(19) United States
(12) Patent Application Publication
(10) Pub. No.: US 2008/0232696 A1
(43) Pub. Date: Sep. 25, 2008

(54) Scene Classification Apparatus and Scene Classification Method

(75) Inventors: Hirokazu KASAHARA, Okaya-shi (JP); Tsuneo KASAI, Azumino-shi (JP); Kaori MATSUMOTO, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/052,632

(22) Filed: Mar. 20, 2008

(30) Foreign Application Priority Data
Mar. 23, 2007 (JP) 2007-077517
Mar. 28, 2007 (JP) 2007-083769
Dec. 5, 2007 (JP) 2007-315247

(51) Int. Cl. G06K 9/62

(52) U.S. Cl. 382/224

(57) ABSTRACT

A scene classification apparatus includes: a characteristic amount obtaining section that obtains a partial characteristic amount indicating a characteristic of a partial image that is a portion of a classification-target image; a partial classification section that classifies, based on the partial characteristic amount, whether or not the partial image belongs to a predetermined scene; a detection section that detects the number of the partial images classified as belonging to the predetermined scene; and a decision section that decides, according to the number of the partial images detected by the detection section, whether or not the classification-target image belongs to the predetermined scene.

### CROSS-REFERENCE TO RELATED APPLICATIONS

The present application claims priority upon Japanese Patent Application No. 2007-077517 filed on Mar. 23, 2007, Japanese Patent Application No. 2007-083769 filed on Mar. 28, 2007, and Japanese Patent Application No. 2007-315247 filed on Dec. 5, 2007, which are herein incorporated by reference.

### BACKGROUND

1. Technical Field

The present invention relates to scene classification apparatuses and scene classification methods.

2. Related Art

Classification apparatuses have been proposed that obtains from a classification-target image characteristic amounts indicating the overall characteristics of the image, and classifies a scene to which the classification-target image belongs (see JP-A-2003-123072). With this classification apparatus, it is possible to automatically classify a specific scene to which a classification-target image belongs, and it is also possible to perform an image processing (adjustment of image quality) appropriate to a specific scene based on the classification result, for example. It should be noted that there is JP-A-2001-238177 as another related art.

(1) This type of classification apparatus demands improvement of the classification accuracy in order to properly perform the image processing, for example. However, there is a risk that, if characteristics of a specific scene partly appear in a classification-target image, the classification accuracy of the above-mentioned classification apparatus deteriorates.

(2) Further, a process is suggested wherein a classification-target image is divided into a plurality of portions (hereinafter referred to as a partial image) and each partial image is classified based on characteristic amounts of the partial image (see JP-A-2004-62605). However, performing the classification for each partial image increases the number of classification processes. Therefore, there is a risk that, as the number of dividing becomes larger (the number of partial images becomes larger), it takes more time to decide whether or not the classification-target image belongs to a specific scene. Particularly, if the classification for a classification-target image wherein characteristics partly appear is started from a partial image positioned far from a portion where characteristics appear and sequentially shifts to an adjacent partial image, it takes considerable time to decide whether or not the classification-target image belongs to a specific scene.

### SUMMARY

The present invention has been made in view of the above issues. A first advantage of some aspects of the invention is to improve the classification accuracy of scenes. In addition, a second advantage is to increase a speed of a classification process.

A first aspect of the invention is a scene classification apparatus including:

a characteristic amount obtaining section that obtains a partial characteristic amount indicating a characteristic of a partial image that is a portion of a classification-target image;

a partial classification section that classifies, based on the partial characteristic amount obtained by the characteristic amount obtaining section, whether or not the partial image belongs to a predetermined scene;

a detection section that detects the number of the partial images classified by the partial classification section as belonging to the predetermined scene; and

a decision section that decides, according to the number of the partial images detected by the detection section, whether or not the classification-target image belongs to the predetermined scene.

A second aspect of the invention is a scene classification apparatus including:

a storage section that stores at least either one of presence probability information indicating, for each of partial regions, a presence probability that a characteristics of the predetermined scene appear, and presence-probability ranking information indicating an order of the presence probability for a plurality of the partial regions, the partial regions being obtained by dividing an entire region of an image belonging to a predetermined scene;

a characteristic amount obtaining section that obtains a partial characteristic amount indicating a characteristic of a partial image that is a portion of a classification-target image and that corresponds to the partial region;

a partial evaluation section that evaluates, based on the partial characteristic amount obtained by the characteristic amount obtaining section, whether or not the partial image belongs to the predetermined scene, in a descending order by the presence probability based on at least either one of the presence probability information and the presence-probability ranking information that are read out from the storage section; and

a decision section that decides, according to an evaluation value obtained by the partial evaluation section, whether or not the classification-target image belongs to the predetermined scene.

### BRIEF DESCRIPTION OF THE DRAWINGS

FIG. 1 is a diagram illustrating a multifunctional apparatus 1 and a digital still camera.

FIG. 2A is a diagram illustrating the configuration of the printing mechanism of the multifunctional apparatus 1.

FIG. 2B is a diagram illustrating a storage section having a memory.

FIG. 3 is a block diagram illustrating the functions realized by the printer-side controller.

FIG. 4 is a diagram illustrating an overview over the configuration of the scene classification section.

FIG. 5 is a diagram illustrating the specific configuration of the scene classification section.

FIG. 6 is a flowchart illustrating how the partial characteristic amounts are obtained.

FIG. 7 is a diagram for illustrating a partial image.

FIG. 8 is a diagram illustrating a linear support vector machine.

FIG. 9 is a diagram illustrating a non-linear support vector machine.

FIG. 10 is a diagram illustrating a positive threshold.

FIG. 11 is a flowchart illustrating an image classification process.

FIG. 12 is a flowchart illustrating a partial classification process.

FIG. 13 is a diagram illustrating a multifunctional apparatus 1 and a digital still camera.

FIG. 14A is a diagram illustrating the configuration of the printing mechanism of the multifunctional apparatus 1.

FIG. 14B is a diagram illustrating a storage section having a memory.

FIG. 15 is a block diagram illustrating the functions realized by the printer-side controller.

FIG. 16 is a diagram illustrating an overview over the configuration of the scene classification section.

FIG. 17 is a diagram illustrating the specific configuration of the scene classification section.

FIG. 18 is a flowchart illustrating how the partial characteristic amounts are obtained.

FIG. 19 is a diagram for illustrating a partial image.

FIG. 20A is a table showing presence probability information of an evening scene.

FIG. 20B is a table showing presence-probability ranking information of the evening scene.

FIG. 21A is a table showing presence probability information of a flower scene.

FIG. 21B is a table showing presence-probability ranking information of the flower scene.

FIG. 22A is a table showing presence probability information of an autumnal scene.

FIG. 22B is a table showing presence-probability ranking information of the autumnal scene.

FIG. 23 is a diagram illustrating a linear support vector machine.

FIG. 24 is a diagram illustrating a non-linear support vector machine.

FIG. 25 is a diagram illustrating a positive threshold.

FIG. 26 is a flowchart illustrating an image classification process.

FIG. 27 is a flowchart illustrating a partial classification process.

### DESCRIPTION OF EXEMPLARY EMBODIMENTS

At least the following matters will be made clear by the present specification and the accompanying drawings.

A scene classification apparatus can be realized that includes: a characteristic amount obtaining section that obtains a partial characteristic amount indicating a characteristic of a partial image that is a portion of a classification-target image; a partial classification section that classifies, based on the partial characteristic amount obtained by the characteristic amount obtaining section, whether or not the partial image belongs to a predetermined scene; a detection section that detects the number of the partial images classified by the partial classification section as belonging to the predetermined scene; and a decision section that decides, according to the number of the partial images detected by the detection section, whether or not the classification-target image belongs to the predetermined scene.

With this scene classification apparatus, even if the characteristic of the predetermined scene partly appear in the classification-target image, the decision section performs the judgment according to the number of partial images classified as belonging to a predetermined scene. Therefore, the classification accuracy can be improved.

In this scene classification apparatus, it is preferable that, if the number of the partial images detected by the detection section exceeds a predetermined threshold, the decision section decides that the classification-target image belongs to the predetermined scene.

With this scene classification apparatus, the classification accuracy can be adjusted by setting the predetermined threshold.

In this scene classification apparatus, it is preferable that the detection section detects the number of remaining images that has not been classified by the partial classification section, among all of the partial images obtained from the classification-target image, and if a sum of the number of the remaining images detected by the detection section and the number of the partial images belonging to the predetermined scene does not reach the predetermined threshold, the decision section decides that the classification-target image does not belong to the predetermined scene.

With this scene classification apparatus, it is possible to abandon a classification process for the specific scene at a point in time when the decision section decides that the classification-target image does not belong to the predetermined scene. Accordingly, classification processing speed can be increased.

In this scene classification apparatus, it is preferable that the partial classification section is provided for each type of the predetermined scene to be classified.

With this scene classification apparatus, the properties of each of the partial classification sections can be optimized, and the classification properties can be improved.

In this scene classification apparatus, it is preferable that the predetermined threshold is set for each of a plurality of the predetermined scenes.

With this scene classification apparatus, it is possible to perform the classification suitable to each of the predetermined scenes.

In this scene classification apparatus, it is preferable that, if in a classification with a first partial classification section, it cannot be decided that the classification-target image belongs to a first predetermined scene, in a classification with a partial classification section other than the first partial classification section, the decision section decides whether or not the classification-target image belongs to a predetermined scene other than the first predetermined scene.

With this scene classification apparatus, classification can be carried out by each of the partial classification sections individually, so that the reliability of the classification can be increased.

In this scene classification apparatus, it is preferable that the partial classification section obtains probability information that indicates a probability that the partial image belongs to the predetermined scene, from the partial characteristic amount corresponding to the partial image, and classifies, based on the probability information, whether or not the partial image belongs to the predetermined scene.

In this scene classification apparatus, it is preferable that the partial classification section is a support vector machine that obtains the probability information from the partial characteristic amount.

In this scene classification apparatus, it is preferable that the characteristic amount obtaining section obtains an overall characteristic amount that indicates a characteristic of the classification-target image, based on the partial characteristic amount and the overall characteristic amount that are obtained by the characteristic amount obtaining section, the partial classification section classifies whether or not the partial image is the predetermined scene.

With this scene classification apparatus, it is possible to increase the classification accuracy.

It should furthermore become clear, that the following scene classification method can be realized.

That is, a scene classification method can be realized that includes: obtaining a partial characteristic amount that indicates a characteristic of a partial image that is a portion of a classification-target image; classifying, based on the obtained partial characteristic amount, whether or not the partial image belongs to a predetermined scene; detecting the number of the partial images classified as belonging to the predetermined scene; and judging, according to the number of the detected partial images, whether or not the classification-target image belongs to the predetermined scene.

Further, A scene classification apparatus can be realized that includes: a storage section that stores at least either one of presence probability information indicating, for each of partial regions, a presence probability that a characteristics of the predetermined scene appear, and presence-probability ranking information indicating an order of the presence probability for a plurality of the partial regions, the partial regions being obtained by dividing an entire region of an image belonging to a predetermined scene; a characteristic amount obtaining section that obtains a partial characteristic amount indicating a characteristic of a partial image that is a portion of a classification-target image and that corresponds to the partial region; a partial evaluation section that evaluates, based on the partial characteristic amount obtained by the characteristic amount obtaining section, whether or not the partial image belongs to the predetermined scene, in a descending order by the presence probability based on at least either one of the presence probability information and the presence-probability ranking information that are read out from the storage section; and a decision section that decides, according to an evaluation value obtained by the partial evaluation section, whether or not the classification-target image belongs to the predetermined scene.

With this scene classification apparatus, classification processing speed can be increased.

In this scene classification apparatus, it is preferable that the partial evaluation section classifies, based on the partial characteristic amount, whether or not the partial image belongs to the predetermined scene, and if the number of the partial images classified by the partial evaluation section as belonging to the predetermined scene exceeds a predetermined threshold, the decision section decides that the classification-target image belongs to the predetermined scene.

With this scene classification apparatus, the classification accuracy can be adjusted by setting the predetermined threshold.

In this scene classification apparatus, it is preferable that at least either one of the presence probability information and the presence-probability ranking information is stored in the storage section for each type of the predetermined scene to be classified.

With this scene classification apparatus, the classification for each specific scene can be performed efficiently.

In this scene classification apparatus, it is preferable that the partial evaluation section is provided for each type of the predetermined scene, and each of the partial evaluation sections classifies the partial image in a descending order by the presence probability of the predetermined scene, based on at least either one of the presence probability information and the presence-probability ranking information that are read out from the storage section corresponding to the predetermined scene to be classified.

With this scene classification apparatus, the properties of each of the partial evaluation sections can be optimized.

In this scene classification apparatus, it is preferable that the predetermined threshold is set for each of a plurality of the predetermined scenes, and if the number of the partial images classified by the partial evaluation section as belonging to a corresponding one of the predetermined scenes exceeds the predetermined threshold set to the corresponding predetermined scene, the decision section decides that the classification-target image belongs to that predetermined scene.

With this scene classification apparatus, it is possible to perform the classification suitable to each of the predetermined scene.

In this scene classification apparatus, it is preferable that if it cannot be decided, based on a classification with a first partial evaluation section, that the classification-target image belongs to a first predetermined scene, the decision section classifies, with a partial evaluation section other than the first partial evaluation section, whether or not the partial image belongs to a predetermined scene other than the first predetermined scene.

With this scene classification apparatus, classification can be carried out by each of the partial evaluation section s individually, so that the reliability of the classification can be increased.

In this scene classification apparatus, it is preferable the characteristic amount obtaining section obtains an overall characteristic amount that indicates a characteristic of the classification-target image, and the partial evaluation section evaluates, based on the partial characteristic amount and the overall characteristic amount that are obtained by the characteristic amount obtaining section, whether or not the partial image belongs to the predetermined scene, in a descending order by the presence probability based on at least either one of the presence probability information and the presence-probability ranking information that are read out from the storage section.

With this scene classification apparatus, it is possible to increase the classification accuracy.

### (1) First Embodiment

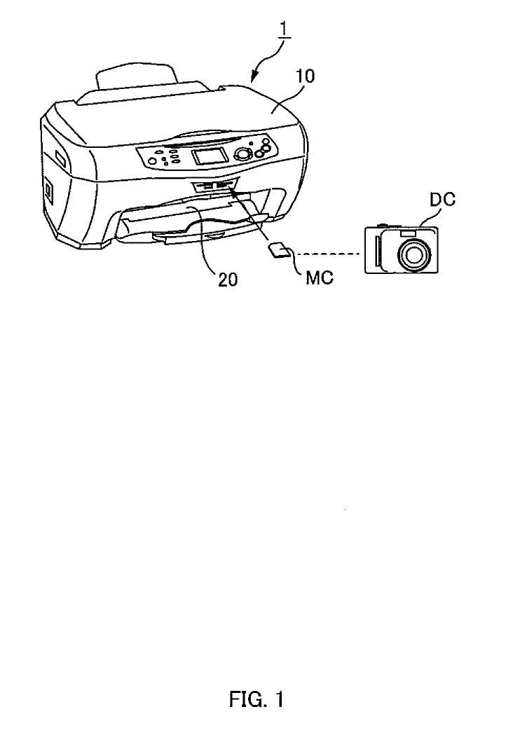

The following is an explanation of embodiments of the present invention. It should be noted that the following explanations take the multifunctional apparatus 1 shown in FIG. 1 as an example. This multifunctional apparatus 1 includes an image reading section 10 that obtains image data by reading an image printed on a medium, and an image printing section 20 that prints the image on a medium, based on the image data. The image printing section 20 prints the image on the medium in accordance with, for example, image data obtained by capturing an image with a digital still camera DC or image data obtained with the image reading section 10. In addition, this multifunctional apparatus 1 classifies scenes for an image that is targeted (classification-target image), and enhances the data of the image in accordance with the classification result or stores the enhanced image data in an external memory, such as a memory card MC. Here, the multifunctional apparatus 1 functions as a scene classification apparatus that classifies a scene of an unknown classification-target image. Moreover, the multifunctional apparatus 1 also functions as a data enhancement apparatus that enhances image data based on the classified scene and as a data storage apparatus that stores the enhanced image data in an external memory.

### Configuration of Multifunctional Apparatus 1

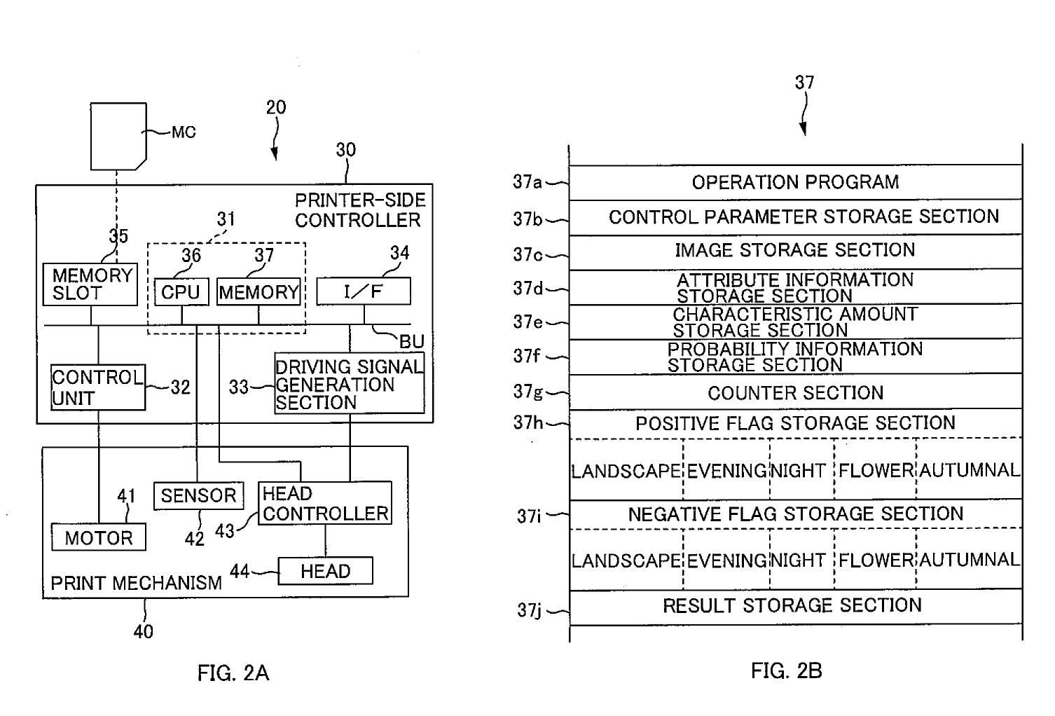

As shown in FIG. 2A, the image printing section 20 includes a printer-side controller 30 and a print mechanism 40.

The printer-side controller 30 is a component that carries out the printing control, such as the control of the print mechanism 40. The printer-side controller 30 shown in FIG. 2A includes a main controller 31, a control unit 32, a driving signal generation section 33, an interface 34, and a memory slot 35. These various components are communicably connected via a bus BU.

The main controller 31 is the central component responsible for control, and includes a CPU 36 and a memory 37. The CPU 36 functions as a central processing unit, and carries out various kinds of control operations in accordance with an operation program stored in the memory 37. Accordingly, the operation program includes code for realizing control operations. The memory 37 stores various kinds of information. As shown for example in FIG. 2B, a portion of the memory 37 is provided with a program storage section 37a storing the operation program, a control parameter storage section 37b storing control parameters such as threshold (to be described later) used in classification process, an image storage section 37c storing image data, an attribute information storage section 37d storing Exif attribute information, a characteristic amount storage section 37e storing characteristic amounts, a probability information storage section 37f storing probability information, a counter section 37g functioning as a counter, a positive flag storage section 37h storing positive flags, a negative flag storage section 37i storing negative flags, and a result storage section 37j storing classification results. The various components constituted by the main controller 31 are explained later.

The control unit 32 controls for example motors 41 with which the print mechanism 40 is provided. The driving signal generation section 33 generates driving signals that are applied to driving elements (not shown in the figures) of a head 44. The interface 34 is for connecting to a host apparatus, such as a personal computer. The memory slot 35 is a component for mounting a memory card MC. When the memory card MC is mounted in the memory slot 35, the memory card MC and the main controller 31 are connected in a communicable manner. Accordingly, the main controller 31 is able to read information stored on the memory card MC and to store information on the memory card MC. For example, it can read image data created by capturing an image with the digital still camera DC or it can store enhanced image data, which has been subjected to enhancement processing or the like.

The print mechanism 40 is a component that prints on a medium, such as paper. The print mechanism 40 shown in the figure includes motors 41, sensors 42, a head controller 43, and a head 44. The motors 41 operate based on the control signals from the control unit 32. Examples for the motors 41 are a transport motor for transporting the medium and a movement motor for moving the head 44 (neither is shown in the figures). The sensors 42 are for detecting the state of the print mechanism 40. Examples for the sensors 42 are a medium detection sensor for detecting whether a medium is present or not, and a transport detection sensor (none of which is shown in the figures). The head controller 43 is for controlling the application of driving signals to the driving elements of the head 44. In this image printing section 20, the main controller 31 generates the head control signals in accordance with the image data to be printed. Then, the generated head control signals are sent to the head controller 43. The head controller 43 controls the application of driving signals, based on the received head control signals. The head 44 includes a plurality of driving elements that perform an operation for ejecting ink. The necessary portion of the driving signals that have passed through the head controller 43 is applied to these driving elements. Then, the driving elements perform an operation for ejecting ink in accordance with the applied necessary portion. Thus, the ejected ink lands on the medium and an image is printed on the medium.

### (1) Configuration of Various Components Realized by Printer-Side Controller 30

The following is an explanation of the various components realized by the printer-side controller 30. The CPU 36 of printer-side controller 30 performs a different operation for each of the plurality of operation modules (program units) constituting the operation program. At this time, the main controller 31 having the CPU 36 and the memory 37 fulfills different functions for each operation module, either alone or in combination with the control unit 32 or the driving signal generation section 33. In the following explanations, it is assumed for convenience that the printer-side controller 30 is expressed as a separate device for each operation module.

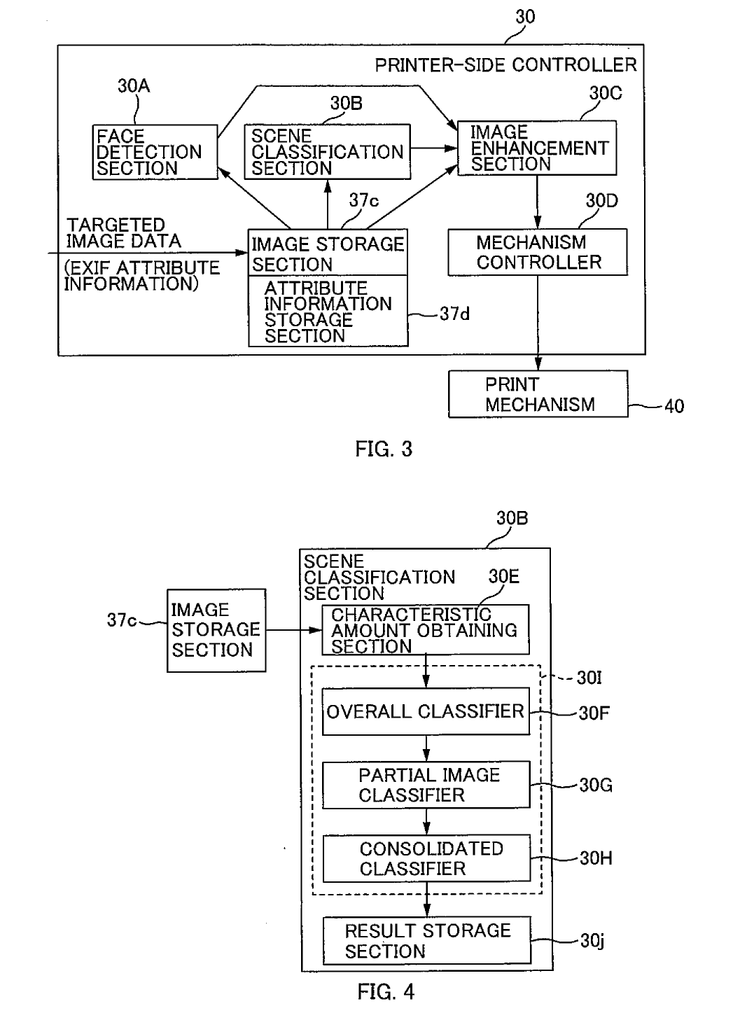

As shown in FIG. 3, the printer-side controller 30 includes an image storage section 37c, an attribute information storage section 37d, a face detection section 30A, a scene classification section 30B, an image enhancement section 30C, and a mechanism controller 30D. The image storage section 37c stores image data to be subjected to scene classification processing or enhancement processing. This image data is one kind of data to be classified (hereinafter referred to as “targeted image data”). In the present embodiment, the targeted image data is constituted by RGB image data. This RGB image data is one type of image data that is constituted by a plurality of pixels including color information. The attribute information storage section 37d stores Exif attribute information that is appended to the image data. The face detection section 30A classifies whether there is an image of a human face in the data of the targeted image, and classifies this as a corresponding scene. For example, the face detection section 30A judges whether an image of a human face is present, based on data of QVGA (320×240 pixels=76800 pixels) size. Then, if an image of a face has been detected, the classification-target image is sorted as a scene with people or as a commemorative photograph, based on the total area of the face image (this is explained later). The scene classification section 30B classifies the scene to which a classification-target image belongs for which the scene could not be determined with the face detection section 30A. The image enhancement section 30C performs an enhancement in accordance with the scene to which the classification-target image belongs, in accordance with the classification result of the face detection section 30A or the scene classification section 30B. The mechanism controller 30D controls the print mechanism 40 in accordance with the data of the targeted image. Here, if an enhancement of the data of the targeted image has been performed with the image enhancement section 30C, the mechanism controller 30D controls the print mechanism 40 in accordance with the enhanced image data. Of these sections, the face detection section 30A, the scene classification section 30B, and the image enhancement section 30C are constituted by the main controller 31. The mechanism controller 30D is constituted by the main controller 31, the control unit 32, and the driving signal generation section 33.

### (1) Configuration of Scene Classification Section 30B

The following is an explanation of the scene classification section 30B. The scene classification section 30B of the present embodiment classifies whether a classification-target image for which the scene has not been determined with the face detection section 30A belongs to a landscape scene, an evening scene, a night scene, a flower scene, an autumnal scene, or another scene. As shown in FIG. 4, the scene classification section 30B includes a characteristic amount obtaining section 30E, an overall classifier 30F, a partial image classifier 30G, a consolidated classifier 30H, and a result storage section 37j. Among these, the characteristic amount obtaining section 30E, the overall classifier 30F, the partial image classifier 30G, and the consolidated classifier 30H are constituted by the main controller 31. Moreover, the overall classifier 30F, the partial image classifier 30G, and the consolidated classifier 30H constitute a classification processing section 30I that performs a process of classifying the scene to which the classification-target image belongs, based on at least one of a partial characteristic amount and an overall characteristic amount.

### (1) Characteristic Amount Obtaining Section 30E

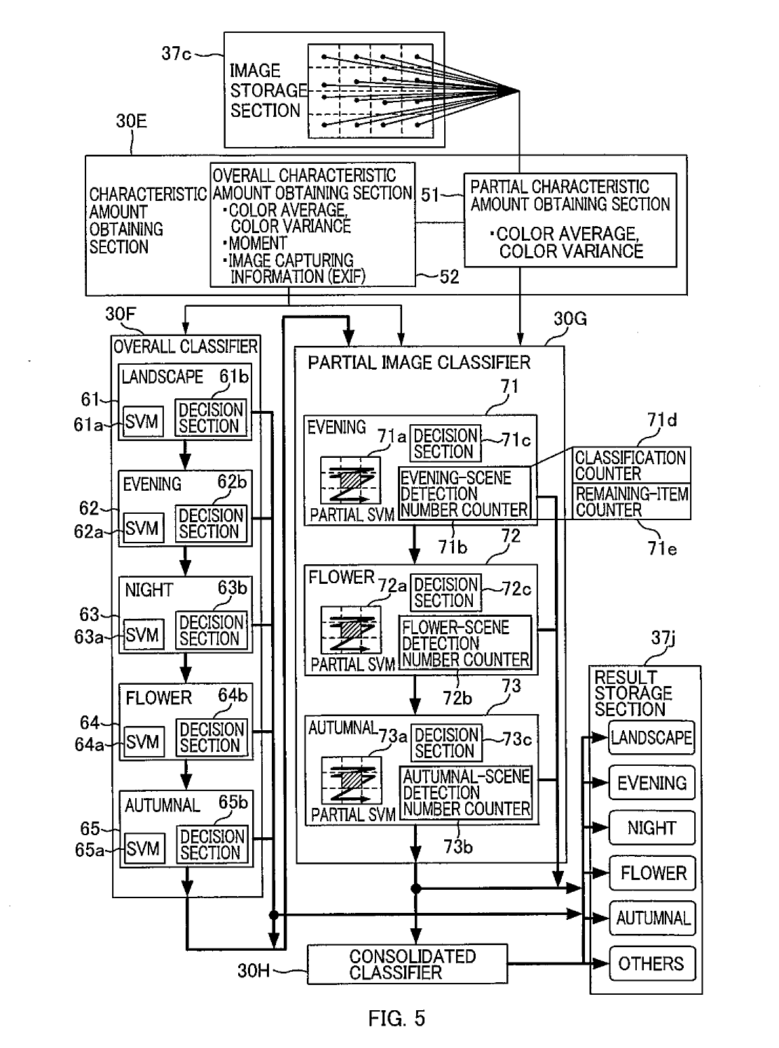

The characteristic amount obtaining section 30E obtains a characteristic amount indicating a characteristic of the classification-target image from the data of the targeted image. This characteristic amount is used for the classification with the overall classifier 30F and the partial image classifier 30G. As shown in FIG. 5, the characteristic amount obtaining section 30E includes a partial characteristic amount obtaining section 51 and an overall characteristic amount obtaining section 52.

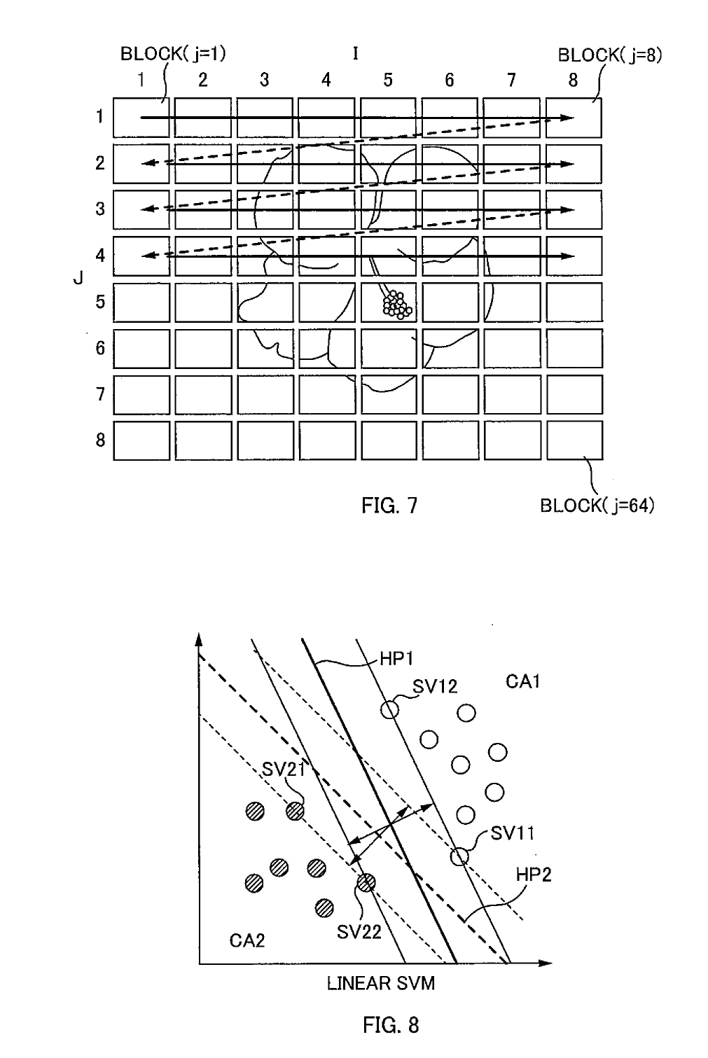

The partial characteristic amount obtaining section 51 obtains partial characteristic amounts for individual partial image data obtained by partitioning the targeted image data. These partial characteristic amounts represent a characteristic of one portion to be classified, corresponding to the partial image data. In this embodiment, an image is subjected to classification. Accordingly, the partial characteristic amounts represent characteristic amounts for each of the plurality of regions into which the classification-target image has been partitioned (also referred to simply as “partial images”). More specifically, as shown in FIG. 7, they represent the characteristic amounts of the partial images of 1/64 size that are obtained by partitioning the overall image into partial images corresponding to regions obtained by splitting width and height of the overall image into eight equal portions, that is, by partitioning the overall image into a grid shape. It should be noted that the data of the targeted image in this embodiment is data of QVGA size. Therefore, the partial image data is data of 1/64 of that size (40×30 pixels=1200 pixels).

The partial characteristic amount obtaining section 51 obtains the color average and the color variance of the pixels constituting the partial image data as the partial characteristic amounts indicating the characteristics of the partial image. The color of the pixels can be expressed by numerical values in a color space such as YCC or HSV. Accordingly, the color average can be obtained by averaging these numerical values. Moreover, the variance indicates the extent of spread from the average value for the colors of all pixels.

The overall characteristic amount obtaining section 52 obtains the overall characteristic amount from the data subjected to classification. This overall characteristic amount indicates an overall characteristic of the targeted image data. Examples of this overall characteristic amount are the color average and the color variance of the pixels constituting the data of the targeted image, and a moment. This moment is a characteristic amount indicating the distribution (centroid) of color. The moment is a characteristic amount that used to be directly obtained from the data of the targeted image. However, the overall characteristic amount obtaining section 52 of the present embodiment obtains these characteristic amounts using the partial characteristic amounts (this is explained later). Moreover, if the data of the targeted image has been generated by capturing an image with the digital still camera DC, then the overall characteristic amount obtaining section 52 obtains also the Exif attribute information as an overall characteristic amount from the attribute information storage section 37d. For example, image capturing information, such as aperture information indicating the aperture, shutter speed information indicating the shutter speed, and strobe information indicating whether a strobe is set or not are also obtained as overall characteristic amounts.

### (1) Obtaining Characteristic Amounts

The following is an explanation of how the characteristic amounts are obtained. With the multifunctional apparatus 1 according to the present embodiment, the partial characteristic amount obtaining section 51 obtains the partial characteristic amounts for each set of partial image data, and stores the obtained partial characteristic amounts in the characteristic amount storage section 37e of the memory 37. The overall characteristic amount obtaining section 52 obtains the overall characteristic amounts by reading out the partial characteristic amounts stored in the characteristic amount storage section 37e. Then, the obtained overall characteristic amounts are stored in the characteristic amount storage section 37e. By employing this configuration, it is possible to keep the number of transformations performed on the data of the targeted image low, and compared to a configuration in which the partial characteristic amounts and the overall characteristic amounts are obtained, the processing speed can be increased. Moreover, the capacity of the memory 37 for the decoding can also be kept to the necessary minimum.

### (1) Obtaining Partial Characteristic Amounts

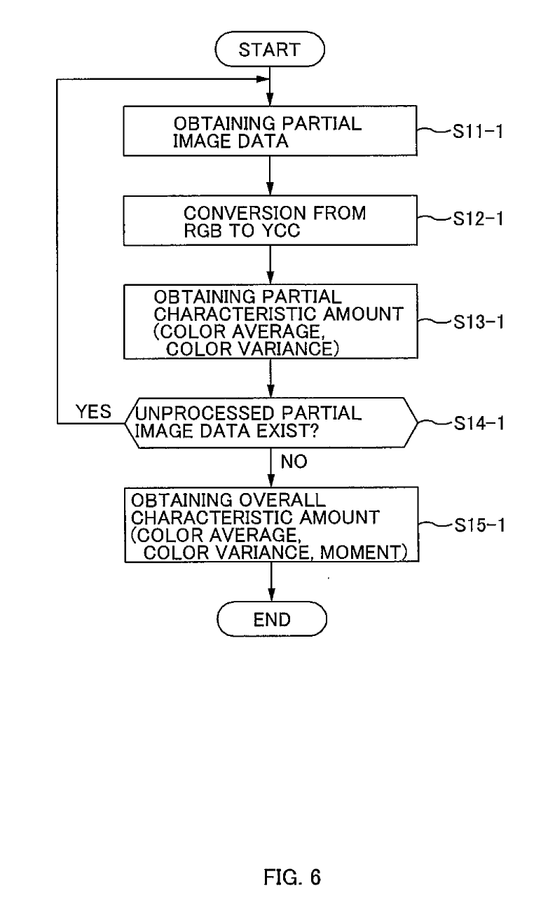

The following is an explanation of how the partial characteristic amounts are obtained by the partial characteristic amount obtaining section 51. As shown in FIG. 6, the partial characteristic amount obtaining section 51 first reads out the partial image data constituting a portion of the data of the targeted image from the image storage section 37c of the memory 37 (S11-1). In this embodiment, the partial characteristic amount obtaining section 51 obtains RGB image data of 1/64 of the QVGA size as partial image data. It should be noted that in the case of image data compressed to JPEG format or the like, the partial characteristic amount obtaining section 51 reads out the data for a single portion constituting the data of the targeted image from the image storage section 37c, and obtains the partial image data by decoding the data that has been read out. When the partial image data has been obtained, the partial characteristic amount obtaining section 51 performs a color space conversion (S12-1). For example, it converts RGB image data into YCC image data.

Then, the partial characteristic amount obtaining section 51 obtains the partial characteristic amounts from the partial image data that has been readout (S13-1). In this embodiment, the partial characteristic amount obtaining section 51 obtains the color average and the color variance of the partial image data as the partial characteristic amounts. For convenience, the color average of the partial image data is also referred to as “partial color average”. Moreover, for convenience, the color variance in the partial image data is also referred to as “partial color variance”. If the classification-target image is partitioned into 64 partial images as illustrated in FIG. 7, in the j-th (j=1 . . . 64) set of partial image data, the color information of the i-th (i=1 . . . 76800) pixel (for example the numerical value expressed in YCC color space) is xᵢ. In this case, the partial color average xₐᵥⱼ for the j-th set of partial image data can be expressed by the following Equation (1):

$${x}_{avj} = \frac{1}{n} {\sum }_{i = 1}^{n} {x}_{i} \qquad ( 1 )$$

Moreover, for the variance S² of the present embodiment, the variance defined in Equation (2) below is used. Therefore, the partial color variance Sⱼ² for the j-th partial image data can be expressed by the following Equation (3), which is obtained by modifying Equation (2).

$$\begin{matrix}{S}^{2} = \frac{1}{n - 1} {\sum }_{i} {( {x}_{i} - {x}_{av} )}^{2} & ( 2 ) \\ {S}_{j}^{2} = \frac{1}{n - 1} ( {\sum }_{i} {x}_{ij}^{2} - {nx}_{avj}^{2} ) & ( 3 )\end{matrix}$$

Consequently, the partial characteristic amount obtaining section 51 obtains the partial color average xₐᵥⱼ and the partial color variance Sⱼ² for the corresponding partial image data by performing the calculations of Equation (1) and Equation (3). Then, the partial color average xₐᵥⱼ and the partial color variance Sⱼ² are stored in the characteristic amount storage section 37e of the memory 37.

When the partial color average xₐᵥⱼ and the partial color variance Sⱼ² have been obtained, the partial characteristic amount obtaining section 51 judges whether there is unprocessed partial image data left (S14-1). If it judges that there is unprocessed partial image data left, then the partial characteristic amount obtaining section 51 returns to Step S11-1 and carries out the same process (S11-1 to S13-1) for the next set of partial image data. On the other hand, if it is judged at Step S14-1 that there is no unprocessed partial image data left, then the processing with the partial characteristic amount obtaining section 51 ends. In this case, the overall characteristic amounts are obtained with the overall characteristic amount obtaining section 52 in Step S15-1.

### (1) Obtaining Overall Characteristic Amounts

The following is an explanation of how the overall characteristic amounts are obtained with the overall characteristic amount obtaining section 52 (S15-1). The overall characteristic amount obtaining section 52 obtains the overall characteristic amounts based on the plurality of partial characteristic amounts stored in the characteristic amount storage section 37e. As noted above, the overall characteristic amount obtaining section 52 obtains the color average and the color variance of the data of the targeted image as the overall characteristic amounts. The color average of the data of the targeted image is also referred to simply as “overall color average”. The color variance of the data of the targeted image is also referred to simply as “overall color variance” Moreover, if the partial color average of the j-th set of partial image data among the 64 sets of partial image data illustrated in FIG. 7 is xₐᵥⱼ, then the overall color average xₐᵥ can be expressed by the Equation (4) below. In this Equation (4), m represents the number of partial images. The overall color variance S² can be expressed by the Equation (5) below. It can be seen that with this Equation (5), it is possible to obtain the overall color variance S² from the partial color averages xₐᵥⱼ, the partial color variances Sⱼ², and the overall color average xₐᵥ.

$$\begin{matrix}{x}_{av} = \frac{1}{m} {\sum }_{j} {x}_{avj} & ( 4 ) \\ \begin{matrix}{S}^{2} = \frac{1}{N - 1} ( {\sum }_{j = 1}^{m} {x}_{ji}^{2} - {Nx}_{av}^{2} ) \\ = \frac{1}{N - 1} ( ( n - 1 ) {\sum }_{j = 1}^{m} {S}_{j}^{2} + n {\sum }_{j = 1}^{m} {x}_{avj}^{2} - {Nx}_{av}^{2} )\end{matrix} & ( 5 )\end{matrix}$$

Consequently, the overall characteristic amount obtaining section 52 obtains the overall color average xₐᵥ and the overall color variance S² for the data of the targeted image by calculating the Equations (4) and (5). Then, the overall color average xₐᵥ and the overall color variance S² are stored in the characteristic amount storage section 37e of the memory 37.

The overall characteristic amount obtaining section 52 obtains the moment as another overall characteristic amount. In this embodiment, an image is to be classified, so that the positional distribution of colors can be quantitatively obtained through the moment. In this embodiment, the overall characteristic amount obtaining section 52 obtains the moment from the color average xₐᵥⱼ for each set of partial image data. Of 64 partial images shown in FIG. 7, a partial image defined by a vertical position J (J=1 to 8) and a horizontal position I (I=1 to 8) is indicated with coordinates (I, J). When a partial color average of data of the partial image defined with the coordinates (I, J) is indicated with X_{AV}(I, J), then the n-th moment mₙₕ in horizontal direction for the partial color average can be expressed as in Equation (6) below.

$${m}_{nh} = {\sum }_{I , J} {I}^{n} \times {x}_{av} ( I , J ) \qquad ( 6 )$$

Here, the value obtained by dividing the simple primary moment by the sum total of the partial color averages X_{AV}(I, J) is referred to as “primary centroid moment”. This primary centroid moment is as shown in Equation (7) below and indicates the centroid position in horizontal direction of the partial characteristic amount of partial color average. The n-th centroid moment, which is a generalization of this centroid moment is as expressed by Equation (8) below. Among the n-th centroid moments, the odd-numbered (n=1, 3 . . . ) centroid moments generally seem to indicate the centroid position. The even-numbered centroid moments generally seem to indicate the extent of the spread of the characteristic amounts near the centroid position.

$$\begin{matrix}{m}_{glh} = {\sum }_{I , J} I \times {x}_{av} ( I , J ) / {\sum }_{I , J} {x}_{av} ( I , J ) & ( 7 ) \\ {m}_{gnh} = {\sum }_{I , J} {( I - {m}_{glx} )}^{n} \times {x}_{av} ( I , J ) / {\sum }_{I , J} {x}_{av} ( I , J ) & ( 8 )\end{matrix}$$

The overall characteristic amount obtaining section 52 of this embodiment obtains six types of moments. More specifically, it obtains the primary moment in a horizontal direction, the primary moment in a vertical direction, the primary centroid moment in a horizontal direction, the primary centroid moment in a vertical direction, the secondary centroid moment in a horizontal direction, and the secondary centroid moment in a vertical direction. It should be noted that the combination of moments is not limited to this. For example, it is also possible to use eight types, adding the secondary moment in a horizontal direction and the secondary moment in a vertical direction.

By obtaining these moments, it is possible to recognize the color centroid and the extent of the spread of color near the centroid. For example, information such as “a red region spreads at the top portion of the image” or “a yellow region is concentrated near the center” can be obtained. With the classification process of the classification processing section 30I (see FIG. 4), the centroid position and the localization of colors can be taken into account, so that the accuracy of the classification can be improved.

### (1) Normalization of Characteristic Amounts

The overall classifier 30F and the partial image classifier 30G constituting a part of the classification processing section 30I perform the classification using support vector machines (also written “SVM”), which are explained later. These support vector machines have the property that their influence (extent of weighting) on the classification increases as the variance of the characteristic amounts becomes larger. Accordingly, the partial characteristic amount obtaining section 51 and the overall characteristic amount obtaining section 52 perform a normalization on the obtained partial characteristic amounts and the overall characteristic amounts. That is to say, the average and the variance is calculated for each characteristic amount, and normalized such that the average becomes “0” and the variance become “1”. More specifically, when μᵢ is the average value and σᵢ is the variance for the i-th characteristic amount xᵢ, then the normalized characteristic amount xᵢ′ can be expressed by the Equation (9) below.

xᵢ′=(xᵢ−μᵢ)/σᵢ (9)

Consequently, the partial characteristic amount obtaining section 51 and the overall characteristic amount obtaining section 52 normalize each characteristic amount by performing the calculation of Equation (9). The normalized characteristic amounts are stored in the characteristic amount storage section 37e of the memory 37, and used for the classification process with the classification processing section 30I. Thus, in the classification process with the classification processing section 301, each characteristic amount can be treated with equal weight. As a result, the classification accuracy can be improved.

### (1) Summary of Characteristic Amount Obtaining Section 30E

The partial characteristic amount obtaining section 51 obtains partial color averages and partial color variances as the partial characteristic amounts, whereas the overall characteristic amount obtaining section 52 obtains overall color averages and overall color variances as the overall characteristic amounts. These characteristic amounts are used for the process of classifying the classification-target image with the classification processing section 30I. Therefore, the classification accuracy of the classification processing section 30I can be increased. This is because in the classification process, information about the coloring and information about the localization of colors is taken into account, which is obtained for the overall classification-target image as well as for the partial images.

### (1) Classification Processing Section 30I

The following is an explanation of the classification processing section 30I. First, an overview of the classification processing section 30I is explained. As shown in FIGS. 4 and 5, the classification processing section 30I includes an overall classifier 30F, a partial image classifier 30G, and a consolidated classifier 30H. The overall classifier 30F classifies the scene of the classification-target image based on the overall characteristic amounts. The partial image classifier 30H classifies the scene of the classification-target image based on the partial characteristic amounts. The consolidated classifier 30H classifies the scene of classification-target image whose scene could be determined neither with the overall classifier 30F nor with the partial image classifier 30G. Thus, the classification processing section 30I includes a plurality of classifiers with different properties. This is in order to improve the classification properties. That is to say, scenes whose characteristics tend to appear in the overall classification-target image can be classified with high accuracy with the overall classifier 30F. By contrast, scenes whose characteristics tend to appear in a portion of the classification-target image can be classified with high accuracy with the partial image classifier 30G. As a result, it is possible to improve the classification properties of the classification-target image. Furthermore, for images where the scene could be determined neither with the overall classifier 30F nor with the partial image classifier 30G, the scene can be classified with the consolidated classifier 30H. Also with regard to this aspect, it is possible to improve the classification properties of the classification-target image.

### (1) Overall Classifier 30F

The overall classifier 30F includes sub-classifiers (also referred to simply as “overall sub-classifiers”), which correspond in number to the number of scenes that can be classified. The overall sub-classifiers classify whether a classification-target image belongs to a specific scene (corresponding to a predetermined scene) based on the overall characteristic amounts. As shown in FIG. 5, the overall classifier 30F includes, as overall sub-classifiers, a landscape scene classifier 61, an evening scene classifier 62, a night scene classifier 63, a flower scene classifier 64, and an autumnal scene classifier 65. Each overall sub-classifier classifies whether a classification-target image belongs to a specific scene. Furthermore, the various overall sub-classifiers classify also whether a classification-target image does not belong to a specific scene.

These overall sub-classifiers each include a support vector machine and a decision section. That is to say, the landscape scene classifier 61 includes a landscape scene support vector machine 61a and a landscape scene decision section 61b, whereas the evening scene classifier 62 includes an evening scene support vector machine 62a and an evening scene decision section 62b. The night scene classifier 63 includes a night scene support vector machine 63a and a night scene decision section 63b, the flower scene classifier 64 includes a flower scene support vector machine 64a and a flower scene decision section 64b, and the autumnal scene classifier 65 includes an autumnal scene support vector machine 65a and an autumnal scene decision section 65b. As discussed below, each time a sample is entered, the support vector machines calculate a classification function value (probability information) depending on the extent to which the sample to be classified belongs to a specific category. Moreover, the classification function value determined by the support vector machines is stored in the probability information storage section 37f of the memory 37.

Decision sections each judges, based on the classification function values obtained with the respective corresponding support vector machine, whether the classification-target image belongs to respective corresponding specific scenes. Then, if each decision section judges that the classification-target image belongs to the specific scene, a positive flag is set in a corresponding region of the positive flag storage section 37h. Besides, each decision section decides, based on the classification function values obtained with the support vector machine, whether the classification-target image does not belong to the specific scene. Then, if each decision section judges that the classification-target image does not belong to the specific scene, a negative flag is set in a corresponding region of the negative flag storage section 37i. It should be noted that the support vector machine is used in the partial image classifier 30G. Therefore, the support vector machine will be described with the partial image classifier 30G.

### (1) Partial Image Classifier 30G

The partial image classifier 30G includes several sub-classifiers (also referred to below simply as “partial sub-classifiers”), corresponding in number to the number of scenes that can be classified. The partial sub-classifiers classify, based on the partial characteristic amounts, whether or not a classification-target image belongs to a specific scene category. That is to say, a classification is performed based on the characteristics of the partial image. If the partial sub-classifiers judge that the classification-target image belongs to a certain scene, then a positive flag is stored in the corresponding region of the positive flag storage section 37h. And if the partial sub-classifiers judge that the classification-target image does not belong to a certain scene, then a negative flag is stored in the corresponding region of the negative flag storage section 37i.

As shown in FIG. 5, the partial image classifier 30G includes, as partial sub-classifiers, an evening-scene partial sub-classifier 71, a flower-scene partial sub-classifier 72, and an autumnal-scene partial sub-classifier 73. The evening-scene partial sub-classifier 71 classifies whether the classification-target image belongs to the evening scene category. The flower-scene partial sub-classifier 72 classifies whether the classification-target image belongs to the flower scene category. The autumnal-scene partial sub-classifier 73 classifies whether the classification-target image belongs to the autumnal scene category. Comparing the number of scene types that can be classified by the overall classifier 30F. with the number of scene types that can be classified by the partial image classifier 30G, the number of scene types that can be classified by the partial image classifier 30G is smaller. This is because the partial image classifier 30G has the purpose of supplementing the overall classifier 30F.

Next, the images suitable for classification with the partial image classifier 30G are considered. First of all, a flower scene and an autumnal scene are considered. In both of these scenes, the characteristics of the scene tend to appear locally. For example, in an image of a flowerbed or a flower field, a plurality of flowers tend to accumulate in a specific portion of the image. In this case, the characteristics of a flower scene appear in the portion where the plurality of flowers accumulate, whereas characteristics that are close to a landscape scene appear in the other portions. This is the same for autumnal scenes. That is to say, if autumn leaves on a portion of a hillside are captured, then the autumn leaves accumulate on a specific portion of the image. Also in this case, the characteristics of an autumnal scene appear in one portion of the hillside, whereas the characteristics of a landscape scene appear in the other portions. Consequently, by using the flower-scene partial sub-classifier 72 and the autumnal-scene partial sub-classifier 73 as partial sub-classifiers, the classification properties can be improved even for flower scenes and for autumnal scenes, which are difficult to classify with the overall classifier 30F. That is to say, the classification is carried out for each partial image, so that even if it is an image in which the characteristics of the essential object, such as flowers or autumnal leaves, appear only in a portion of the image, it is possible to perform the classification with high accuracy. Next, evening scenes are considered. Also in evening scenes, the characteristics of the evening scene may appear locally. For example, let us consider an image in which the evening sun is captured as it sets at the horizon, and the image is captured immediately prior to the complete setting of the sun. In this image, the characteristics of a sunset scene appear at the portion where the evening sun sets, whereas the characteristics of a night scene appear in the other portions. Consequently, by using the evening-scene partial sub-classifier 71 as the partial sub-classifier, the classification properties can be improved even for evening scenes that are difficult to classify with the overall classifier 30F.

Thus, the partial image classifier 30G mainly performs the classification of images that are difficult to classify accurately with the overall classifier 30F. Therefore, no partial sub-classifiers are provided for classification objects for which a sufficient accuracy can be attained with the overall classifier 30F. By employing this configuration, the configuration of the partial image classifier 30G can be simplified. Here, the partial image classifier 30G is configured by the main controller 31, so that a simplification of its configuration means that the size of the operating program executed by the CPU 36 and/or the volume of the necessary data is reduced. Through a simplification of the configuration, the necessary memory capacity can be reduced and the processing can be sped up.

### (1) Partial Image

In the present embodiment, the partial image is an image obtained by splitting width and height of the classification-target image into eight equal portions having a grid shape, as shown in FIG. 7. Accordingly, the classification-target image is partitioned into partial images of 64 blocks with eight by eight. As mentioned above, a partial image that is defined by the vertical position J (J=1 to 8) and the horizontal position I (I=1 to 8) is indicated with coordinates (I, J).

Image data of the classification-target image is data of QVGA size (320×240 pixels=76800 pixels). Therefore, partial image data of one block consists of data of 1/64 of the size of that block (40×30 pixels 1200 pixels).

Each of partial sub-classifiers of the partial image classifier 30G reads out partial characteristic amounts of coordinates corresponding to each partial image, from the characteristic amount storage section 37e of the memory 37. Then, based on the partial characteristic amounts, the partial sub-classifiers classify whether or not each partial image belongs to a specific scene. In the partial image classifier 30G, the classification by each partial sub-classifier is sequentially performed for each partial image. For example, as shown in FIG. 7, the classification starts from a partial image having coordinates (1,1), which both of I, J are minimum values; and then, the value of I is increased and the classification sequentially shifts to a horizontally-adjacent partial image. When a partial image having coordinates (8,1), which is a last horizontal position, has been classified, J is set to J=2 and the classification starts from a partial image having coordinates (1,2), which is a partial image in a next lower line, and then, the classification sequentially shifts to a horizontally-adjacent partial image. Thereafter, similar operations are repeated and it is classified whether or not the partial image belongs to a specific scene. That is, it is the partial image having coordinates (1,1) that the classification is performed first, and it is the partial image having coordinates (8,8) that the classification is performed 64th.

The order of the classification of the partial images is stored, for example, in a operation program 37a of the memory 37. It should be noted that the order of the classification described above is one of examples, and the order is not limited thereto.

### (1) Configuration of Partial Sub-Classifier

As shown in FIG. 5, each partial sub-classifier includes a partial support vector machine, a detection number counter, and a decision section. In each partial sub-classifier, the partial support vector machine serves as a partial classification section that classifies, based on partial characteristic amounts, whether or not a partial image belongs to a specific scene, and the detection number counter serves as a detection section that detects the number of partial images classified as belonging to the specific scene.

The evening-scene partial sub-classifier 71 includes an evening-scene partial support vector machine 71a, an evening-scene detection number counter 71b, and an evening-scene decision section 71c; the flower-scene partial sub-classifier 72 includes a flower-scene partial support vector machine 72a, a flower-scene detection number counter 72b, and a flower-scene decision section 72c. The autumnal-scene partial sub-classifier 73 includes an autumnal-scene support vector machine 73a, an autumnal-scene detection number counter 73b, and an autumnal-scene decision section 73c. It should be noted that the partial support vector machines (the evening-scene partial support vector machine 71a to autumnal-scene support vector machine 73a) are similar machine to the support vector machines included in each overall sub-classifier (the landscape scene support vector machine 61a to the autumnal scene support vector machine 65a). The support vector machine is explained in the following.

### (1) Support Vector Machines

The support vector machines obtain probability information indicating whether the probability that the object to be classified belongs to a certain category is large or small, based on the characteristic amounts indicating the characteristics of the image to be classified. The basic form of the support vector machines is that of linear support vector machines. As shown in FIG. 8 for example, a linear support vector machine implements a linear classification function that is determined by sorting training with two classes, this classification function being determined such that the margin (that is to say, the region for which there are no support vectors in the training data) becomes maximal. In FIG. 8, of white circles, a circle that contributes to determination of a separation hyperplane (e.g. SV11) are support vectors belonging to a certain category CA1, and, of the hatched circles, a circle that contributes to determination of the separation hyperplane (e.g. SV22) are support vectors belonging to another category CA2. At the separating hyperplane that separates the support vectors belonging to category CA1 from the support vectors belonging to category CA2, the classification function (probability information) determining this separation hyperplane has the value “0”. FIG. 8 shows a separation hyperplane HP1 that is parallel to the straight line through the support vectors SV11 and SV12 belonging to category CA1 and a separation hyperplane HP2 that is parallel to the straight line through the support vectors SV21 and SV22 belonging to category CA2 as candidates for the separation hyperplane. In this example, the margin (a distance between a support vector to the separation hyperplane) of the separation hyperplane HP1 is larger than that of the separation hyperplane HP2, so that a classification function corresponding to the separation hyperplane HP1 is determined as the linear support vector machine.

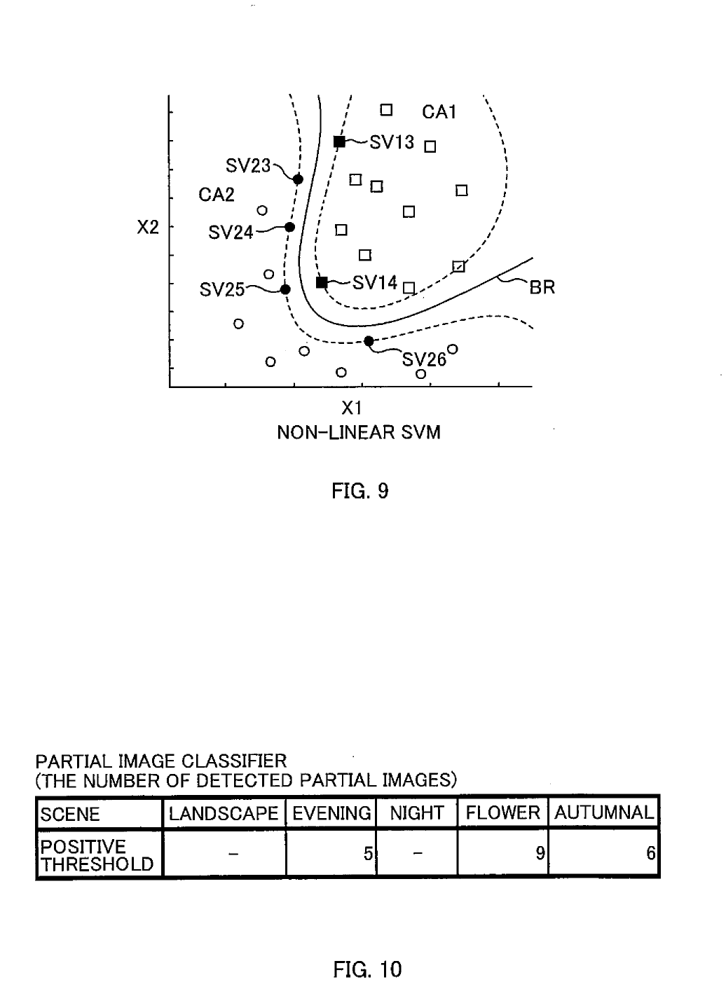

Now, with linear support vector machines, their classification accuracy for images to be classified that cannot be linearly separated is low. It should be noted that the classification-target image that are handled by the multifunctional apparatus 1 correspond to objects to be classified that cannot be linearly separated. Accordingly, for such an object to be classified, the characteristic amounts are converted non-linearly (that is, mapped to a higher-dimensional space), and a non-linear support vector machine performing linear classification in this space is used. With such a non-linear support vector machine, a new number that is defined by a suitable number of non-linear functions is taken as data for the non-linear support vector machines. As shown diagrammatically in FIG. 9, in a non-linear support vector machine, the classification border BR becomes curved. In this example, of points represented by squares, a point that contributes to determination of classification border BR (e.g. SV13, SV14) are support vectors belonging to the category CA1, whereas, of points represented by circles, a point that contributes to determination of classification border BR (e.g. SV23 to SV26) are support vectors belonging to the category CA2. The training used for these support vectors is determined by the parameters of the classification function. It should be noted that the other points are used for the training, but not to the extent that they affect the optimization. Therefore, the volume of the training data (support vectors) used during the classification can be reduced by using support vector machines for the classification. As a result, it is possible to improve the accuracy of the obtained probability information even with limited training data.

### (1) Partial Support Vector Machines

Partial support vector machines included in the respective partial sub-classifiers (a evening-scene partial support vector machine 71a, flower-scene partial support vector machine 72a, and autumnal-scene support vector machine 73a) are non-linear support vector machines as mentioned above. In each of the support vector machines, the parameters in the classification function are determined by training based on different support vectors. As a result, the properties of each of the partial sub-classifiers can be optimized, and it is possible to improve the classification properties of the partial image classifier 30G. Each of the partial support vector machines outputs a numerical value, that is, a classification function value, which depends on the entered sample.

Each partial support vector machine is different from the support vector machines of the overall sub-classifier with regard to the fact that their training data is partial image data. Consequently, each partial support vector machine carries out a calculation based on the partial characteristic amounts indicating the characteristics of the portions to be classified. The more characteristics of the given scene to be classified the partial image has, the larger is the value of the calculation result by each partial support vector machine, that is, the classification function value. By contrast, the more characteristics of another scene that is not to be classified that partial image has, the smaller is that value of the calculation result. It should be noted that if that partial image has an even amount of both the characteristics of the given scene and the characteristics of the other scenes, then the classification function value obtained with the partial support vector machine becomes “0”.

Consequently, with regard to partial images where the classification function value obtained with a partial support vector machine has a positive value, more characteristics of the scene that is handled by that partial support vector machine appear than characteristics of other scenes, that is, the partial images are more likely to belong to the handled scenes. Thus, the classification function value obtained with the partial support vector machine corresponds to probability information indicating the probability that this partial image belongs to a certain scene. The probability information obtained by each partial support vector machine is stored in the probability information storage section 37f of the memory 37.

The partial support vector machines of the present embodiment perform their calculation taking into account the overall characteristic amounts in addition to the partial characteristic amounts. This is for increasing the classification accuracy of the partial images. The following is an explanation of this aspect. The partial images contain less information than the overall image. Therefore, it occurs that the classification of scenes is difficult. For example, if a given partial image has characteristics that are common for a given scene and another scene, then their classification becomes difficult. Let us assume that the partial image is an image with a strong red tone. In this case, it may be difficult to classify with the partial characteristic amounts alone whether the partial image belongs to an evening scene or whether it belongs to an autumnal scene. In this case, it may be possible to classify the scene to which this partial image belongs by taking into account the overall characteristic amounts. For example, if the overall characteristic amounts indicate an image that is predominantly black, then the probability is high that the partial image with the strong red tone belongs to an evening scene. And if the overall characteristic amounts indicate an image that is predominantly green or blue, then the probability is high that the partial image with the strong red tone belongs to an autumnal scene. Thus, the classification accuracy of the partial support vector machines can be increased by performing the calculation while taking into account the overall characteristic amounts.

### (1) Counters

The detection number counters (evening-scene detection number counter 71b to autumnal-scene detection number counter 73b) functions under the counter section 37g of the memory 37. Besides, the detection number counters each include a counter that counts the number of partial images classified as belonging to a specific scene (also referred to simply as “classification counter”), and a counter that counts the number of partial images that has not been classified, among all partial images that the classification-target image consists of (also referred to simply as “remaining-item counter”). For example, as shown in FIG. 5, the evening-scene detection number counter 71b includes a classification counter 71d and a remaining-item counter 71e.

The classification counter 71d is set to “0” as an initial value, and is incremented (+1) every time when obtaining a classification result that a classification function value obtained with the evening-scene partial support vector machine 71a is greater than zero, that is, a classification result that the characteristics of the evening scene are stronger than the characteristics of the other scenes. In short, the classification counter 71d counts the number of partial images classified as belonging to the evening scene. The remaining-item counter 71e is set to a value indicating all partial images (e.g. “64”) as an initial number, and the remaining-item counter 71e is decremented (−1) every time when one partial image is classified. Count values of the counters are reset when, for example, a process for another classification-target image is performed. It should be noted that, the flower-scene detection number counter 72b and the autumnal-scene detection number counter 73b include their respective classification counter and remaining-item counter in a similar manner to the evening-scene detection number counter 71b, but they are not shown in FIG. 5 for convenience. In the following explanation, count values of each classification counter are referred to as the number of detected images. Count values of each remaining-item counter are referred to as the number of remaining images.

In the present embodiment, as shown in FIG. 5, the detection number counters (the evening-scene detection number counter 71b to the autumnal-scene detection number counter 73b) are provided for each partial sub-classifier. However, if count values are reset every time when changing a partial sub-classifier that performs classification, it is possible to use one common detection number counter for all partial sub-classifiers.

### (1) Decision Sections

Each of decision sections (the evening-scene decision section 71c, the flower-scene decision section 72c, and the autumnal-scene decision section 73c) is configured with the CPU 36 of the main controller 31, for example, and decides, according to the number of images detected by a corresponding detection number counter, whether or not a classification-target image belongs to a specific scene. Thus, even if the characteristics of the specific scene appears only in a portion of the classification-target image, the classification can be performed with high accuracy by deciding whether or not the classification-target image belongs to the specific scene, according to the number of detected images, that is, the number of partial images classified as belonging to the specific scene. Accordingly, classification accuracy can be increased. More specifically, if the number of images detected by the evening-scene detection number counter 71b exceed a predetermined threshold stored in the control parameter storage section 37b of the memory 37, the evening-scene decision section 71c decides that a classification-target image in question belongs to the evening scene. The predetermined threshold gives a positive decision that the classification-target image belongs to the scene handled by the partial sub-classifier. Consequently, in the following explanations, this threshold for making such a positive decision is also referred to as “positive threshold”. According to the value of the positive threshold, the number of partial images necessary to decide that a classification-target image belongs to a specific scene, that is, a ratio of a region of the specific scene in the classification-target image is decided, so that classification accuracy can be adjusted by setting the positive threshold. It can be considered that the best number of detected images for this decision is different from each specific scene in terms of processing speed and classification accuracy. Therefore, the positive threshold is set to different value depending on each of specific scenes to be classified by the respective partial sub-classifiers. In this embodiment, as shown in FIG. 10, values are set to “5” for the evening scene, “9” for the flower scene, and “6” for the autumnal scene. For example, in the evening-scene partial sub-classifier 71, when the number of images detected by the evening-scene detection number counter 71b exceeds “5”, the evening-scene decision section 71c decides that a classification-target image in question belongs to the evening scene. Thus, since a positive threshold is set for each specific scene, it is possible to perform the classification suitable to the specific scene.

Further, each decision section adds the number of detected images detected by the classification counter and the number of remaining images detected by the remaining-item counter. If the sum is smaller than the positive threshold, the number of detected images, which is finally obtained, will not reach the positive threshold set to a corresponding specific scene even when all remaining images are classified as belonging to the specific scene. For example, in the evening-scene partial sub-classifier 71, as shown in FIG. 7, when sequentially performing classifications for 64 partial images, the number of remaining images detected by the remaining-item counter 72c is “3” after a classification for a partial image having coordinates (5,8) is performed. At this stage, if the number of detected images detected by the classification counter 71d is “1”, the positive threshold will not reach “5” even when the remaining three partial images are classified as belonging to the evening scene. Accordingly, without classification processes for 62nd or later partial images, the evening-scene decision section 71c can decide that the classification-target image does not belong to the evening scene. If a sum of the number of detected images and the number of remaining images is smaller than the positive threshold, each decision section decides that a classification-target image in question does not belong to a specific scene. This enables to decide, during the classification of the partial image, that the classification-target image does not belong to the specific scene. Therefore, it is possible to stop (abandon) a classification process for the specific scene before classifying the last partial image having coordinates (8,8) Accordingly, classification processing speed can be increased.

In the present embodiment, first, the evening-scene partial sub-classifier 71 performs the classification. The evening-scene partial support vector machine 71a of the evening-scene partial sub-classifier 71 obtains a classification function value based on partial characteristic amounts of each partial image. The classification counter 71d counts classification results whose classification function values obtained by the evening-scene partial support vector machine 71a are positive and obtains the number of detected images. The evening-scene decision section 71c decides, according to the number of detected images detected by the classification counter 71d, whether or not a classification-target image in question belongs to the evening scene. As a result of this classification, if it cannot be decided that the classification-target image belongs to the evening scene, the evening-scene decision section 71c lets the flower-scene decision section 72c of the subsequent flower-scene partial sub-classifier 72 use the flower-scene partial support vector machine 72a and decide whether or not each partial image belongs to the flower scene. Further, As a result of this classification, if it cannot be decided that the classification-target image belongs to the flower scene, the flower-scene decision section 72c lets the autumnal-scene decision section 73c of the subsequent autumnal-scene partial sub-classifier 73 use the autumnal-scene partial support vector machine 73a and decide whether or not each partial image belongs to the autumnal scene. In other words, if each decision section of the partial image classifier 30G cannot decide, based on a classification by a certain partial support vector machine, that a classification-target image belongs to a certain specific scene, the decision section uses another partial support vector machine and let it classify whether or not each partial image belongs to the other specific scene. Since the classification is performed by each partial support vector machine individually in this manner, the reliability of the classification can be increased.

### (1) Consolidated Classifier 30H

As mentioned above, the consolidated classifier 30H classifies the scenes of classification-target image for which the scene could be decided neither with the overall classifier 30F nor with the partial image classifier 30G. The consolidated classifier 30H of the present embodiment classifies scenes based on the probability information determined with the overall sub-classifiers (the support vector machines). More specifically, the consolidated classifier 30H selectively reads out the probability information for positive values from the plurality of sets of probability information stored in the probability information storage section 37f of the memory 37 in the overall classification process by the overall classifier 30F. Then, the probability information with the highest value among the sets of probability information that have been read out is specified, and the corresponding scene is taken as the scene of the classification-target image. By providing such a consolidated classifier 30H, it is possible to classify suitable scenes, even when the characteristics of the scene to which the image belongs do not appear strongly in the classification-target image. That is to say, it is possible to improve the classification properties.

### (1) Result Storage Section 37j

The result storage section 37j stores the classification results of the object to be classified that have been determined by the classification processing section 30I. For example, if, based on the classification results according to the overall classifier 30F. and the partial image classifier 30G, a positive flag is stored in the positive flag storage section 37h, then the information is stored that the classification-target image belongs to the scene corresponding to this positive flag. If a positive flag is set that indicates that the classification-target image belongs to a landscape scene, then result information indicating that the classification-target image belongs to a landscape scene is stored. Similarly, if a positive flag is set that indicates that the classification-target image belongs to an evening scene, then result information indicating that the classification-target image belongs to an evening scene is stored. It should be noted that for classification-target image for which a negative flag has been stored for all scenes, result information indicating that the classification-target image belongs to another scene is stored. The classification result stored in the result storage section 37j is looked up by later processes. In the multifunctional apparatus 1, the image enhancement section 30C (see FIG. 3) looks up the classification result and uses it for an image enhancement. For example, the contrast, brightness, color balance or the like can be adjusted in accordance with the classified scene.

### (1) Image Classification Process

The following is an explanation of the image classification process. In execution of this image classification process, the printer-side controller 30 functions as a face detection section 30A and a scene classification section 30B (characteristic amount obtaining section 30E, overall classifier 30F, partial image classifier 30G, consolidated classifier 30H, and result storage section 37j). In this case, the CPU 36 of the main controller 31 run a computer program stored in the memory 37. Accordingly, an image classification process is described as a process of the main controller 31. Moreover, the computer program executed by the main controller 31 includes code for realizing the image classification process.

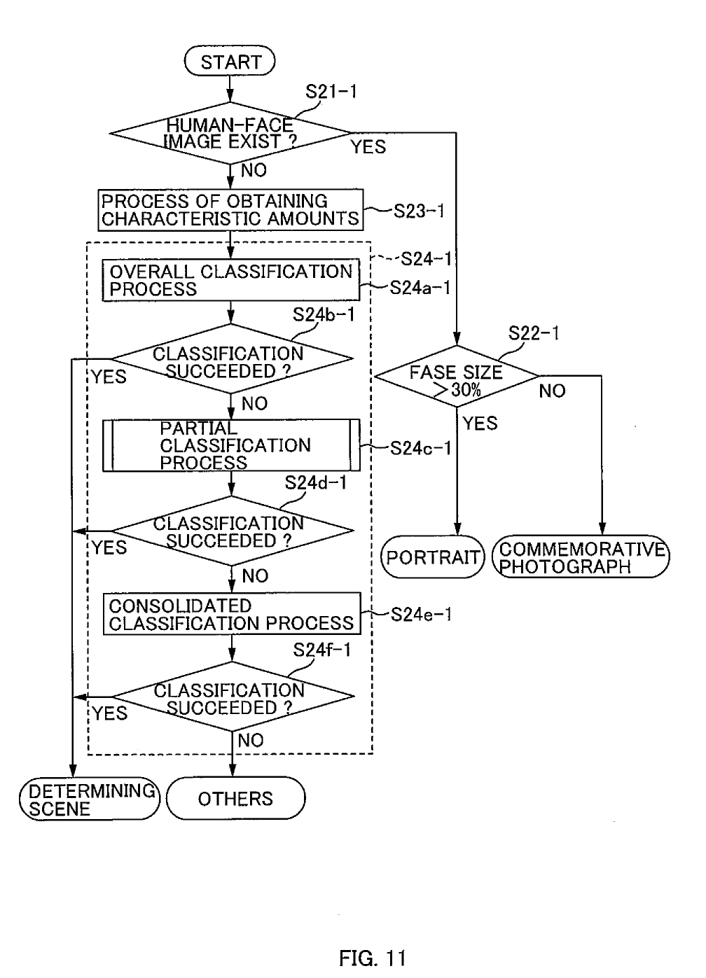

As shown in FIG. 11, the main controller 31 reads in data of an image to be processed, and judges whether it contains a face image (S21-1). The presence of a face image can be judged by various methods. For example, the main controller 31 can determine the presence of a face image based on the presence of a region whose standard color is skin-colored and the presence of an eye image and a mouth image within that region. In the present embodiment, it is assumed that a face image of at least a certain area (for example, at least 20×20 pixels) is subject to detection. If it is judged that there is a face image, then the main controller 31 obtains the proportion of the area of the face image in the classification-target image and judges whether this proportion exceeds a predetermined threshold (e.g. 30%) (S22-1). Then, if the predetermined threshold exceeds 30%, the main controller 31 classifies the classification-target image as a portrait scene (Yes in S22-1). If the predetermined threshold is not exceeded does not exceed 30%, then the main controller 31 classifies the classification-target image as a scene of a commemorative photograph (No in S22-1). The classification results are stored in the result storage section 37j.

If the classification-target image contains no face image (No in S21-1), then the main controller 31 carries out a process of obtaining characteristic amounts (S23-1). In the process of obtaining the characteristic amounts, the characteristic amounts are obtained based on the data of the classification-target image. That is to say, the overall characteristic amounts indicating the overall characteristics of the classification-target image and the partial characteristic amounts indicating the partial characteristics of the classification-target image are obtained. It should be noted that the obtaining of these characteristic amounts has already been explained above (see S11-1 to S15-1, FIG. 6), and further explanations are omitted. Then, the main controller 31 stores the obtained characteristic amounts in the characteristic amount storage section 37e of the memory 37.

When the characteristic amounts have been obtained, the main controller 31 performs a scene classification process (S24-1). In this scene classification process, the main controller 31 first functions as the overall classifier 30F and performs an overall classification process (S24a-1). In this overall classification process, classification is performed based on the overall characteristic amounts. Then, when the classification-target image could be classified by the overall classification process, the main controller 31 determines the scene of the classification-target image as the classified scene (YES in S24b-1). For example, it determines the image to be the scene for which a positive flag has been stored in the overall classification process. Then, it stores the classification result in the result storage section 37j. If the scene was not determined in the overall classification process, then the main controller 31 functions as a partial image classifier 30G and performs a partial image classification process (S24c-1). In this partial image classification process, classification is performed based on the partial characteristic amounts. Then, if the classification-target image could be classified by the partial image classification process (YES in S24d-1), the main controller 31 determines the scene of the classification-target image as the classified scene, and stores the classification result in the result storage section 37j. It should be noted that the details of the partial image classification process are explained later. If the scene was also not determined by the partial image classifier 30G (NO in S24d-1), then the main controller 31 functions as a consolidated classifier 30H and performs a consolidated classification process (S24e-1). In this consolidated classification process, the main controller 31 reads out, among pieces of probability information calculated in the overall classification process, the probability information with positive values from the probability information storage section 37f and determines the image to be a scene corresponding to the probability information with the largest value, as explained above. Then, if the classification-target image could be classified by the consolidated classification process, the main controller 31 determines the scene of the classification-target image as the classified scene (YES in S24f-1). On the other hand, if the classification-target image could also not be classified by the consolidated classification process, and negative flags have been stored for all scenes, then the classification-target image is classified as being another scene (NO in S24f-1). It should be noted that in the consolidated process, the main controller 31 functioning as the consolidated classifier 30H first judges whether negative flags are stored for all scenes. Then, if it is judged that negative flags are stored for all scenes, the image is classified as being another scene, based on this judgment. In this case, the processing can be performed by confirming only the negative flags, so that the processing can be sped up.

### (1) Partial Image Classification Process

The following is an explanation of the partial image classification process. As mentioned above, the partial classification process is performed when a classification-target image cannot be classified in the overall classification process. Accordingly, at the stage when the partial classification process is performed, the positive flag is not stored in the positive flag storage section 37h. Further, for a scene which it is decided in the overall classification process that the classification-target image does not belong to, the negative flag is stored in a corresponding region of the negative flag storage section 37i.

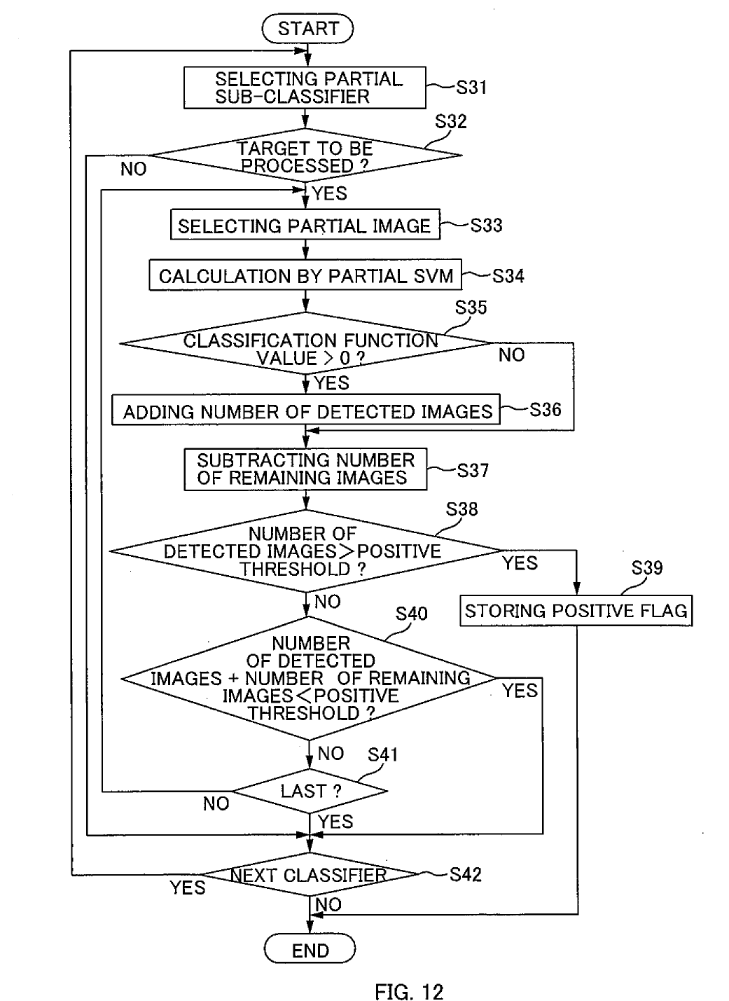

As shown in FIG. 12, the main controller 31 first selects a partial sub-classifier to perform classification (S31). As shown in FIG. 5, in the partial image classifier 30G of the present embodiment, the evening-scene partial sub-classifier 71, the flower-scene partial sub-classifier 72, and the autumnal-scene partial sub-classifier 73 are ordered by priority in that order. Consequently, the evening-scene partial sub-classifier 71, which has the highest priority, is selected in the initial selection process. Then, when the classification with the evening-scene partial sub-classifier 71 is finished, the flower-scene partial sub-classifier 72, which has the second highest priority, is selected, and after the flower-scene partial sub-classifier 72, the autumnal-scene partial sub-classifier 73, which has the lowest priority, is selected.

When a partial sub-classifier has been selected, the main controller 31 judges whether the scene classified by the selected partial sub-classifier is subjected to classification processing (S32). This judgment is carried out based on negative flags that are stored in the negative flag storage section 37i in the overall classification process by the overall classifier 30F. This is because when positive flags are set with the overall classifier 30F, the scene is decided by the overall classification process and the partial classification process is not carried out, and because, when positive flag is stored in the partial classification process, the scene is decided and the classification process ends as mentioned below. For a scene that is not to be classified, that is, a scene for which the negative flag is set in the overall classification process, the classification process is skipped (NO in S32). Therefore, unnecessary classification processing is eliminated, so that the processing can be sped up.

On the other hand, if in Step S32 it is decided that the scene classified by the selected partial sub-classifier is subjected to classification processing, the main controller 31 selects one of partial images that is a portion of the classification-target image, in an order shown in FIG. 7, for example (S33). Then, the main controller 31 reads out partial characteristic amounts corresponding to partial image data of the selected partial image from the characteristic amount storage section 37e of the memory 37. Based on the partial characteristic amounts, a calculation with the partial support vector machine is carried out (S34). In other words, probability information for the partial image is obtained based on the partial characteristic amounts. It should be noted that, in the present embodiment, in addition to the partial characteristic amounts, the overall characteristic amounts are also read out from the characteristic amount storage section 37e, and the calculation is performed by taking into account the overall characteristic amounts. The partial support vector machine obtains the classification function value serving as the probability information by a calculation based on the partial color average, the partial color variance, and the like. The main controller 31 classifies, based on the obtained classification function value, whether or not the partial image belongs to a specific scene (S35). More specifically, if the obtained classification function value corresponding to a certain partial image is a positive value, the partial image is classified as belonging to the specific scene (YES in S35). A count value of a corresponding detection number counter (the number of detected images) is incremented (+1) (S36). If the classification function value is not a positive value, then the partial image is classified as not belonging to the specific scene, and the count value of the detection number counter stays the same (NO in S35). By obtaining the classification function value in this manner, the classification whether or not the partial image belongs to the specific scene can be performed depending on whether or not the classification function value is positive.

Further, main controller 31 decrements (−1) a count value of a corresponding remaining-item counter (the number of remaining images) (S37). In the detection number counters, count values of their respective classification counter and remaining-item counter are reset to the initial value when performing a process for a new classification-target image.

If, for the partial image, probability information has been obtained and counters has been processed, the main controller 31 functions as each decision section, and decides whether the number of detected images is greater than a positive threshold (S38). For example, if a positive threshold shown in FIG. 10 is set in the evening-scene partial sub-classifier 71, when the number of detected images exceeds “5”, the main controller 31 decides that the classification-target image is the evening scene. Then, a positive flag corresponding to the evening scene is stored in the positive flag storage section 37h (S39). Further, for the flower-scene partial sub-classifier 72, if the number of detected images exceeds “9”, the main controller 31 decides that the classification-target image is the flower scene. Then, a positive flag corresponding to the flower scene is stored in the positive flag storage section 37h. If the positive flag are stored, the classification ends without performing remaining classification processes.

If the number of detected images does not exceed the positive threshold (NO in S38), the main controller 31 decides whether a sum of the number of detected images and the number of remaining images is smaller than the positive threshold (S40).

As mentioned above, if the sum is smaller than the positive threshold, the number of detected images, which is finally obtained, will not reach the positive threshold set to a corresponding specific scene even when all remaining images are classified as belonging to the specific scene. Accordingly, if the sum is smaller than the positive threshold, it is possible to decide, before classifying the last partial image, that the classification-target image does not belongs to the specific scene. Then, if the sum of the number of detected images and the number of remaining images is smaller than the positive threshold (YES in S40), the main controller 31 decides that the classification-target image does not belong to the specific scene, and stops the classification process for the specific scene, which the main controller 31 performs as a partial sub-classifier. In the Step S42 mentioned below, it is judged whether or not there is a next partial sub-classifier to be handled.

If the sum of the number of detected images and the number of remaining images is not smaller than positive threshold (NO in S40), it is decided whether the partial image for which the classification has been performed is the last image (S41). For example, as shown in FIG. 7, if the number of partial images to be classified is 64, it is decided whether the partial image is 64th image (S41). This decision can be made based on the number of remaining images. That is, if the number of remaining images is not “0”, the partial image is not the last image; if the number of remaining images is “0”, the partial image is the last image.

Here, if it is decided that the partial image is not the last image (NO in S41), the procedure advances to Step S33 and the above-described process is repeated. On the other hand, if it is decided, in Step S41, that the partial image is the last image (YES in S41), or, if the sum of the number of detected images and the number of remaining images is smaller than the positive threshold in Step S40 (YES in S40), or, if in Step S32 it is not decided that the scene classified by the selected partial sub-classifier is subjected to classification processing, (NO in S32), it is judged whether or not there is a next partial sub-classifier to be handled (S42). At this stage, the main controller 31 judges whether the process has been finished that is handled by the autumnal-scene partial sub-classifier 73, which has the lowest priority. If the process handled by the autumnal-scene partial sub-classifier 73 has been finished, the main controller 31 judges that there is no next partial sub-classifier (NO in S42), and stops a series of procedures of the partial classification process. On the other hand, if the process handled by the autumnal-scene partial sub-classifier 73 has not been finished (YES in S42), the main controller 31 selects a partial sub-classifier having the next highest priority (S31), and the above-described process is repeated.

### (1) Comprehensive Description

Each partial sub-classifier of the partial image classifier 30G in the present embodiment classifies whether or not a corresponding partial image belongs to a specific scene, based on the probability information obtained from the partial characteristic amounts. And the partial sub-classifier counts the number of partial images that classified as belonging to the specific scene (the number of detected images), with a corresponding detection number counter. According to the count values, each decision section decides whether or not a classification-target image in question belongs to a specific scene. Thus, since it is decided whether or not the classification-target image belongs to the specific scene, according to the number of partial images classified as belonging to the specific scene, it is possible to improve classification accuracy even when the characteristics of the specific scene appears only in a portion of the classification-target image.

Further, if the number of detected images, which is obtained by the counter section, exceeds the positive threshold, each decision section of the partial image classifier 30G decides that the classification-target image belongs to the specific scene. Therefore, it is possible to adjust classification accuracy by changing setting of the positive threshold. Each decision section calculates a sum of the number of detected images and the number of remaining images. If the sum does not reach the positive threshold, the decision section decides that the classification-target image does not belong to the specific scene. This makes it possible to abandon a classification process for the specific scene before classifying the last partial image. Accordingly, classification processing speed can be increased.

The partial image classifier 30G has partial support vector machines for each type of the specific scene to be classified. Therefore, the properties of each of partial support vector machines can be optimized, and it is possible to improve the classification properties of the partial image classifier 30G.

Further, in the partial image classifier 30G, positive thresholds are set for each of a plurality of specific scenes. This allows each of partial sub-classifiers to perform the classification suitable to the respective specific scenes.

Further, if in the classification by the partial support vector machines of the partial sub-classifier, it cannot be decided that a classification-target image belongs to a corresponding specific scene, each decision section of the partial image classifier 30G uses a partial support vector machine of a subsequent partial sub-classifier, and decide whether or not belonging to a corresponding specific scene. Therefore, classification can be carried out by each of the partial sub-classifiers individually, so that the reliability of the classification can be increased.

Further, each partial support vector machine obtains classification function values (probability information) indicating a probability that a partial image belongs to a specific scene from partial characteristic amounts, and performs the classification based on the classification function values. More specifically, if the classification function value is positive, the partial support vector machine can classify the partial image as belonging to the specific scene; if the classification function value is not positive, the partial support vector machine can classify the partial image as not belonging to the specific scene.

Further, in calculation by the partial support vector machine of each partial sub-classifier, overall characteristic amounts are taken into account in addition to partial characteristic amounts. Thus, since calculation is performed taking into account the overall characteristic amounts in addition to the partial characteristic amounts, it is possible to increase classification accuracy.

### (2) Second Embodiment

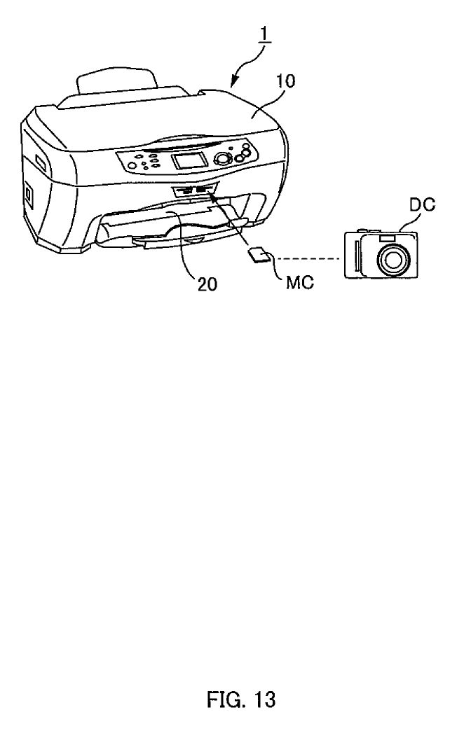

The following is an explanation of the second embodiment of the present invention. It should be noted that the following explanations take the multifunctional apparatus 1 shown in FIG. 13 as an example. This multifunctional apparatus 1 includes an image reading section 10 that obtains image data by reading an image printed on a medium, and an image printing section 20 that prints the image on a medium, based on the image data. The image printing section 20 prints the image on the medium in accordance with, for example, image data obtained by capturing an image with a digital still camera DC or image data obtained with the image reading section 10. In addition, this multifunctional apparatus 1 classifies scenes for a classification-target image, and enhances the data of the image in accordance with the classification result or stores the enhanced image data in an external memory, such as a memory card MC. Here, the multifunctional apparatus 1 functions as a scene classification apparatus that classifies a scene of an unknown classification-target image. Moreover, the multifunctional apparatus 1 also functions as a data enhancement apparatus that enhances image data based on the classified scene and as a data storage apparatus that stores the enhanced image data in an external memory.

### (2) Configuration of Multifunctional Apparatus 1

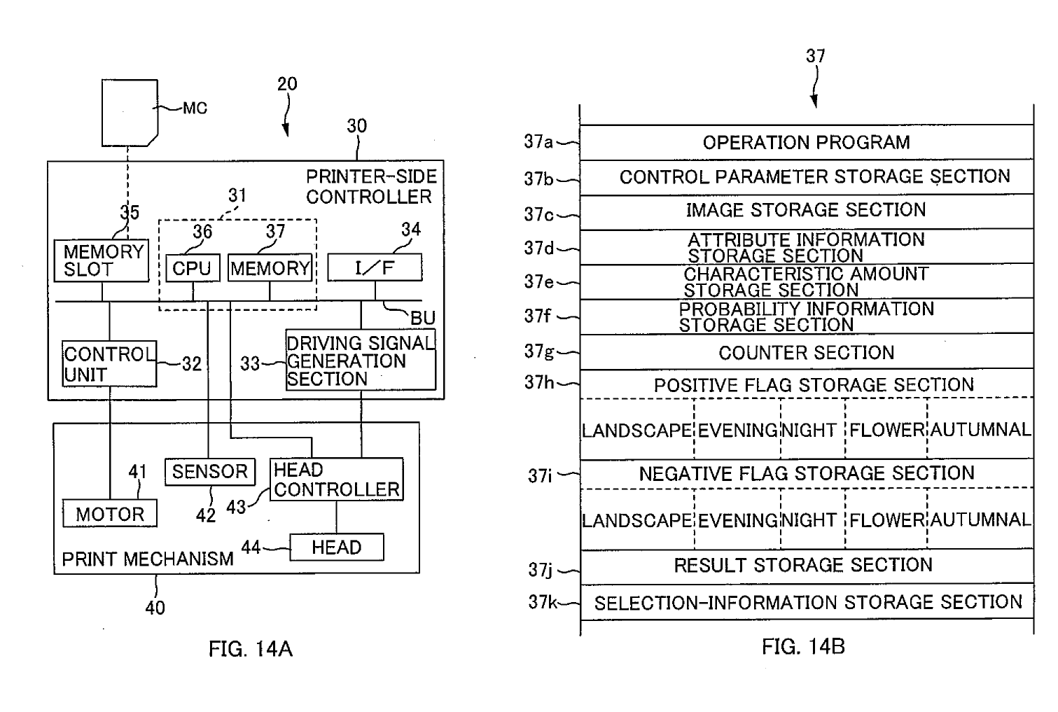

As shown in FIG. 14A, the image printing section 20 includes a printer-side controller 30 and a print mechanism 40.

The printer-side controller 30 is a component that carries out the printing control, such as the control of the print mechanism 40. The printer-side controller 30 shown in FIG. 14A includes a main controller 31, a control unit 32, a driving signal generation section 33, an interface 34, and a memory slot 35. These various components are communicably connected via a bus BU.

The main controller 31 is the central component responsible for control, and includes a CPU 36 and a memory 37. The CPU 36 functions as a central processing unit, and carries out various kinds of control operations in accordance with an operation program stored in the memory 37. Accordingly, the operation program includes code for realizing control operations. The memory 37 stores various kinds of information. As shown for example in FIG. 14B, a portion of the memory 37 is provided with a program storage section 37a storing the operation program, a control parameter storage section 37b storing control parameters such as threshold (to be described later) used in classification process, an image storage section 37c storing image data, an attribute information storage section 37d storing Exif attribute information, a characteristic amount storage section 37e storing characteristic amounts, a probability information storage section 37f storing probability information, a counter section 37g functioning as a counter, a positive flag storage section 37h storing positive flags, a negative flag storage section 37i storing negative flags, a result storage section 37j storing classification results, and a selection-information storage section 37k storing information that is for deciding an order of partial images to be selected in a partial classification process (to be described later). The various components constituted by the main controller 31 are explained later.

The control unit 32 controls for example motors 41 with which the print mechanism 40 is provided. The driving signal generation section 33 generates driving signals that are applied to driving elements (not shown in the figures) of a head 44. The interface 34 is for connecting to a host apparatus, such as a personal computer. The memory slot 35 is a component for mounting a memory card MC. When the memory card MC is mounted in the memory slot 35, the memory card MC and the main controller 31 are connected in a communicable manner. Accordingly, the main controller 31 is able to read information stored on the memory card MC and to store information on the memory card MC. For example, it can read image data created by capturing an image with the digital still camera DC or it can store enhanced image data, which has been subjected to enhancement processing or the like.

The print mechanism 40 is a component that prints on a medium, such as paper. The print mechanism 40 shown in the figure includes motors 41, sensors 42, a head controller 43, and a head 44. The motors 41 operate based on the control signals from the control unit 32. Examples for the motors 41 are a transport motor for transporting the medium and a movement motor for moving the head 44 (neither is shown in the figures). The sensors 42 are for detecting the state of the print mechanism 40. Examples for the sensors 42 are a medium detection sensor for detecting whether a medium is present or not, and a transport detection sensor (none of which is shown in the figures). The head controller 43 is for controlling the application of driving signals to the driving elements of the head 44. In this image printing section 20, the main controller 31 generates the head control signals in accordance with the image data to be printed. Then, the generated head control signals are sent to the head controller 43. The head controller 43 controls the application of driving signals, based on the received head control signals. The head 44 includes a plurality of driving elements that perform an operation for ejecting ink. The necessary portion of the driving signals that have passed through the head controller 43 is applied to these driving elements. Then, the driving elements perform an operation for ejecting ink in accordance with the applied necessary portion. Thus, the ejected ink lands on the medium and an image is printed on the medium.

### (2) Configuration of Various Components Realized by Printer-Side Controller 30

The following is an explanation of the various components realized by the printer-side controller 30. The CPU 36 of printer-side controller 30 performs a different operation for each of the plurality of operation modules (program units) constituting the operation program. At this time, the main controller 31 having the CPU 36 and the memory 37 fulfills different functions for each operation module, either alone or in combination with the control unit 32 or the driving signal generation section 33. In the following explanations, it is assumed for convenience that the printer-side controller 30 is expressed as a separate device for each operation module.

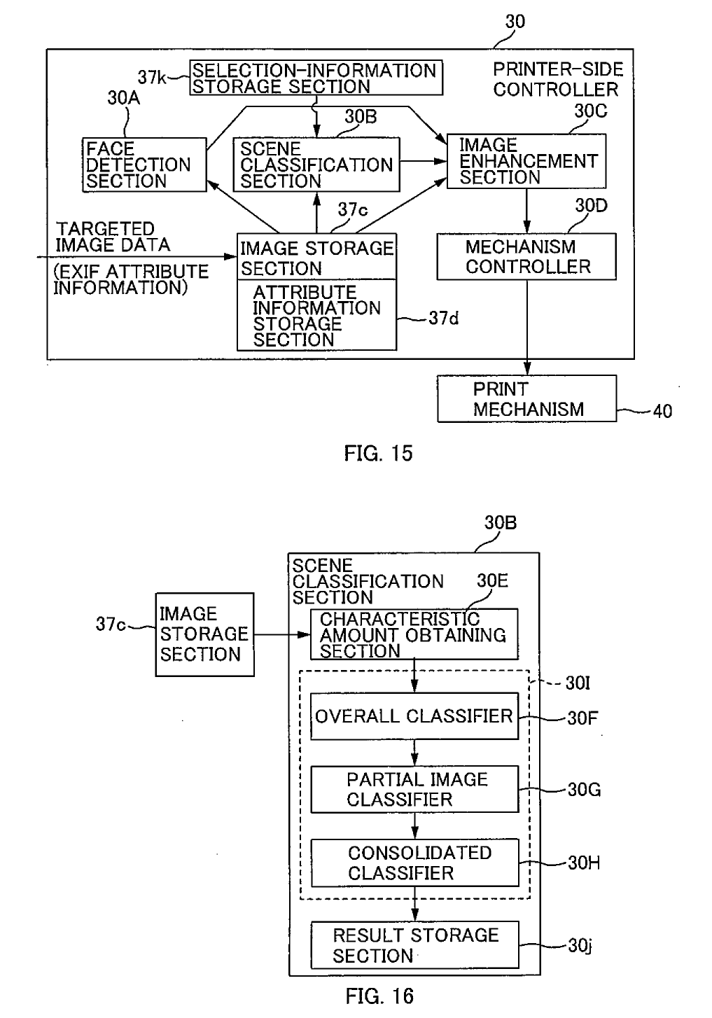

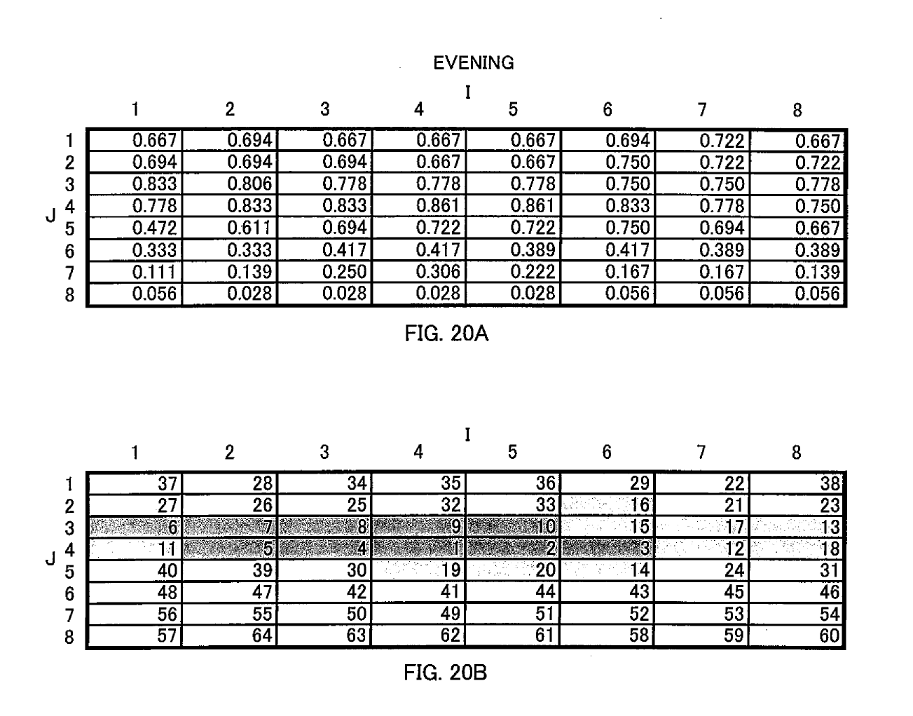

As shown in FIG. 15, the printer-side controller 30 includes an image storage section 37c, an attribute information storage section 37d, a selection-information storage section 37k (storage section), a face detection section 30A, a scene classification section 30B, an image enhancement section 30C, and a mechanism controller 30D. The image storage section 37c stores image data to be subjected to scene classification processing or enhancement processing. This image data is one kind of data to be classified (hereinafter referred to as “targeted image data”). In the present embodiment, the targeted image data is constituted by RGB image data. This RGB image data is one type of image data that is constituted by a plurality of pixels including color information. The attribute information storage section 37d stores Exif attribute information that is appended to the image data. The selection-information storage section 37k stores information for deciding an order of partial images that is to be selected when the evaluation is performed for each of the partial images, which are obtained by partitioning a classification-target image into a plurality of regions. In the present embodiment, as information for deciding the order, at least either one of presence probability information and presence-probability ranking information (see FIGS. 20A and 20B; to be described later) is stored. The face detection section 30A classifies whether there is an image of a human face in the data of the targeted image, and classifies this as a corresponding scene. For example, the face detection section 30A judges whether an image of a human face is present, based on data of QVGA (320×240 pixels=76800 pixels) size. Then, if an image of a face has been detected, the classification-target image is sorted as a scene with people or as a commemorative photograph, based on the total area of the face image (this is explained later). The scene classification section 30B classifies the scene to which a classification-target image belongs for which the scene could not be determined with the face detection section 30A. The image enhancement section 30C performs an enhancement in accordance with the scene to which the classification-target image belongs, in accordance with the classification result of the face detection section 30A or the scene classification section 30B. The mechanism controller 30D controls the print mechanism 40 in accordance with the data of the targeted image. Here, if an enhancement of the data of the targeted image has been performed with the image enhancement section 30C, the mechanism controller 30D controls the print mechanism 40 in accordance with the enhanced image data. Of these sections, the face detection section 30A, the scene classification section 30B, and the image enhancement section 30C are constituted by the main controller 31. The mechanism controller 30D is constituted by the main controller 31, the control unit 32, and the driving signal generation section 33.

### (2) Configuration of Scene Classification Section 30B

The following is an explanation of the scene classification section 30B. The scene classification section 30B of the present embodiment classifies whether a classification-target image for which the scene has not been determined with the face detection section 30A belongs to a landscape scene, an evening scene, a night scene, a flower scene, an autumnal scene, or another scene. As shown in FIG. 16, the scene classification section 30B includes a characteristic amount obtaining section 30E, an overall classifier 30F, a partial image classifier 30G, a consolidated classifier 30H, and a result storage section 37j. Among these, the characteristic amount obtaining section 30E, the overall classifier 30F, the partial image classifier 30G, and the consolidated classifier 30H are constituted by the main controller 31. Moreover, the overall classifier 30F, the partial image classifier 30G, and the consolidated classifier 30H constitute a classification processing section 30I that performs a process of classifying the scene to which the classification-target image belongs, based on at least one of a partial characteristic amount and an overall characteristic amount.

### (2) Characteristic Amount Obtaining Section 30E

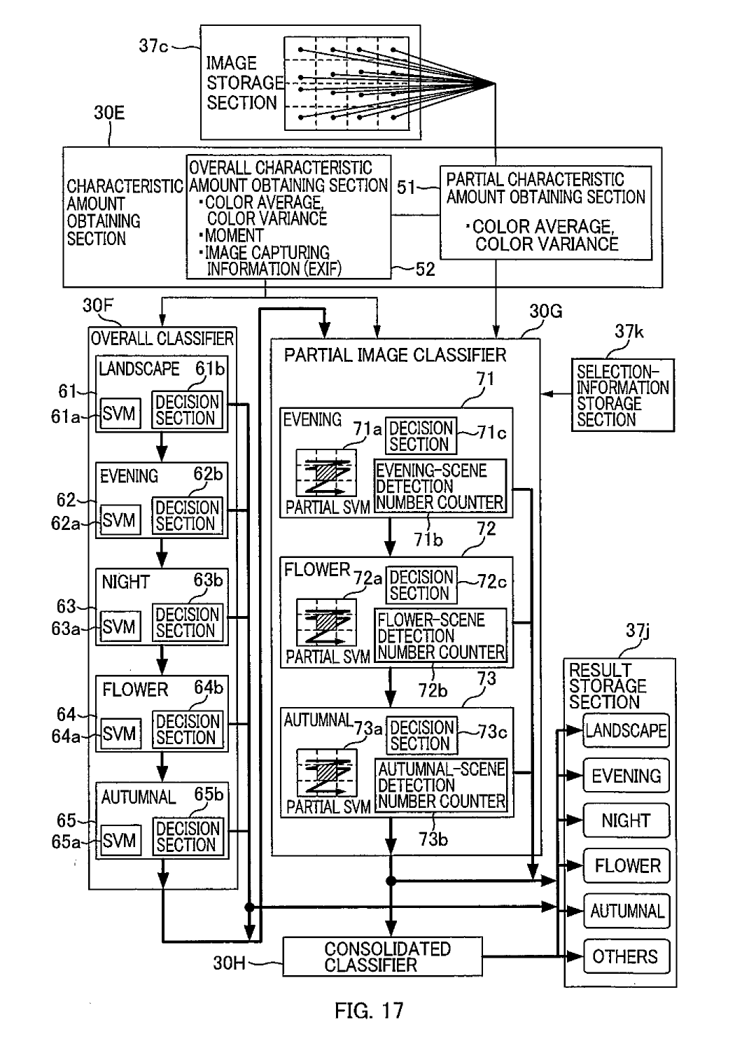

The characteristic amount obtaining section 30E obtains a characteristic amount indicating a characteristic of the classification-target image from the data of the targeted image. This characteristic amount is used for the classification with the overall classifier 30F and the partial image classifier 30G. As shown in FIG. 17, the characteristic amount obtaining section 30E includes a partial characteristic amount obtaining section 51 and an overall characteristic amount obtaining section 52.

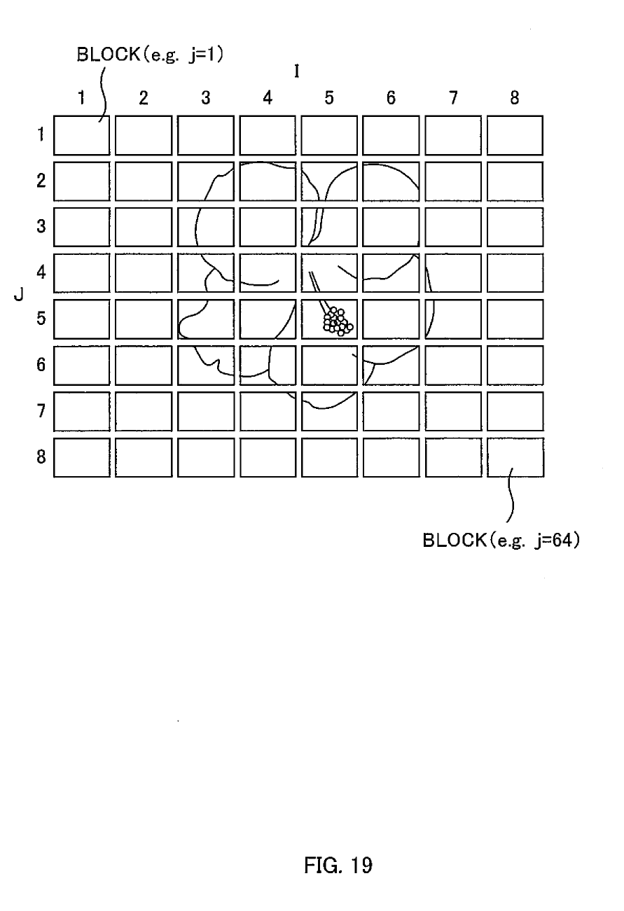

The partial characteristic amount obtaining section 51 obtains partial characteristic amounts for individual partial image data obtained by partitioning the targeted image data. These partial characteristic amounts represent a characteristic of a partial image corresponding to the partial image data. More specifically, as shown in FIG. 19, they represent the characteristic amounts of the partial images of 1/64 size that are obtained by partitioning the overall image into partial images corresponding to regions obtained by splitting width and height of the overall image into eight equal portions, that is, by partitioning the overall image into a grid shape. It should be noted that the data of the targeted image in this embodiment is data of QVGA size. Therefore, the partial image data is data of 1/64 of that size (40×30 pixels=1200 pixels).

The partial characteristic amount obtaining section 51 obtains the color average and the color variance of the pixels constituting the partial image data as the partial characteristic amounts indicating the characteristics of the partial image. The color of the pixels can be expressed by numerical values in a color space such as YCC or HSV. Accordingly, the color average can be obtained by averaging these numerical values. Moreover, the variance indicates the extent of spread from the average value for the colors of all pixels.

The overall characteristic amount obtaining section 52 obtains the overall characteristic amount from the data subjected to classification. This overall characteristic amount indicates an overall characteristic of the targeted image data. Examples of this overall characteristic amount are the color average and the color variance of the pixels constituting the data of the targeted image, and a moment. This moment is a characteristic amount indicating the distribution (centroid) of color. The moment is a characteristic amount that used to be directly obtained from the data of the targeted image. However, the overall characteristic amount obtaining section 52 of the present embodiment obtains these characteristic amounts using the partial characteristic amounts (this is explained later). Moreover, if the data of the targeted image has been generated by capturing an image with the digital still camera DC, then the overall characteristic amount obtaining section 52 obtains also the Exif attribute information as an overall characteristic amount from the attribute information storage section 37d. For example, image capturing information, such as aperture information indicating the aperture, shutter speed information indicating the shutter speed, and strobe information indicating whether a strobe is set or not are also obtained as overall characteristic amounts.

### (2) Obtaining Characteristic Amounts

The following is an explanation of how the characteristic amounts are obtained. With the multifunctional apparatus 1 according to the present embodiment, the partial characteristic amount obtaining section 51 obtains the partial characteristic amounts for each set of partial image data, and stores the obtained partial characteristic amounts in the characteristic amount storage section 37e of the memory 37. The overall characteristic amount obtaining section 52 obtains the overall characteristic amounts by reading out the partial characteristic amounts stored in the characteristic amount storage section 37e. Then, the obtained overall characteristic amounts are stored in the characteristic amount storage section 37e. By employing this configuration, it is possible to keep the number of transformations performed on the data of the targeted image low, and compared to a configuration in which the partial characteristic amounts and the overall characteristic amounts are obtained, the processing speed can be increased. Moreover, the capacity of the memory 37 for the decoding can also be kept to the necessary minimum.

### (2) Obtaining Partial Characteristic Amounts

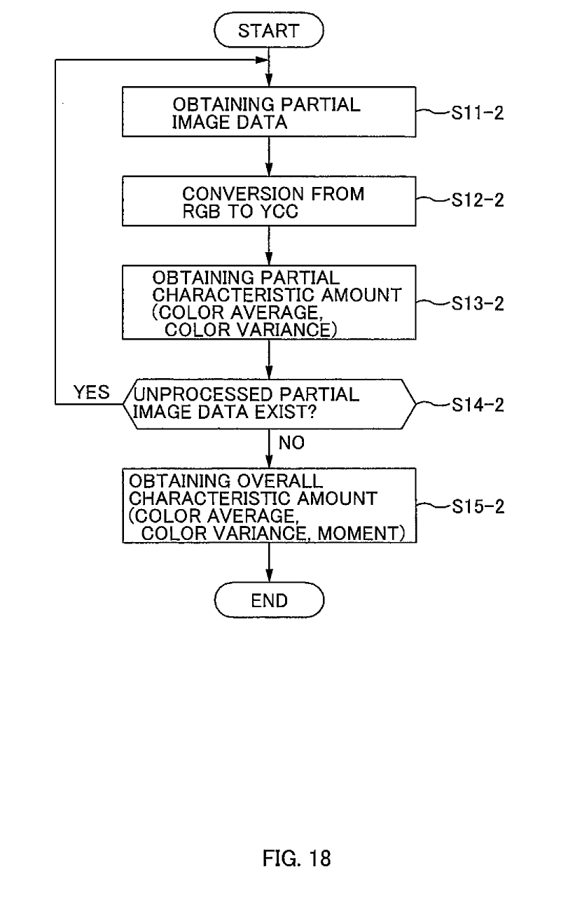

The following is an explanation of how the partial characteristic amounts are obtained by the partial characteristic amount obtaining section 51. As shown in FIG. 18, the partial characteristic amount obtaining section 51 first reads out the partial image data constituting a portion of the data of the targeted image from the image storage section 37c of the memory 37 (S11-2). In this embodiment, the partial characteristic amount obtaining section 51 obtains RGB image data of 1/64 of the QVGA size as partial image data. It should be noted that in the case of image data compressed to JPEG format or the like, the partial characteristic amount obtaining section 51 reads out the data for a single portion constituting the data of the targeted image from the image storage section 37c, and obtains the partial image data by decoding the data that has been readout. When the partial image data has been obtained, the partial characteristic amount obtaining section 51 performs a color space conversion (S12-2). For example, it converts RGB image data into YCC image data.

Then, the partial characteristic amount obtaining section 51 obtains the partial characteristic amounts from the partial image data that has been readout (S13-2). In this embodiment, the partial characteristic amount obtaining section 51 obtains the color average and the color variance of the partial image data as the partial characteristic amounts. For convenience, the color average of the partial image data is also referred to as “partial color averaged”. Moreover, for convenience, the color variance in the partial image data is also referred to as “partial color variance”. If the classification-target image is partitioned into partial images of 64 blocks and the partial images are ordered in any sequence as illustrated in FIG. 19, in the j-th (j=1 . . . 64) set of partial image data, the color information of the i-th (i=1 . . . 76800) pixel (for example the numerical value expressed in YCC color space) is xᵢ. In this case, the partial color average xₐᵥⱼ for the j-th set of partial image data can be expressed by the following Equation (1):

$${x}_{avj} = \frac{1}{n} {\sum }_{i = 1}^{n} {x}_{i} \qquad ( 1 )$$

Moreover, for the variance S² of the present embodiment, the variance defined in Equation (2) below is used. Therefore, the partial color variance Sⱼ² for the j-th partial image data can be expressed by the following Equation (3), which is obtained by modifying Equation (2).

$$\begin{matrix}{S}^{2} = \frac{1}{n - 1} {\sum }_{i} {( {x}_{i} - {x}_{av} )}^{2} & ( 2 ) \\ {S}_{j}^{2} = \frac{1}{n - 1} ( {\sum }_{i} {x}_{ij}^{2} - {nx}_{avj}^{2} ) & ( 3 )\end{matrix}$$

Consequently, the partial characteristic amount obtaining section 51 obtains the partial color average xₐᵥⱼ and the partial color variance Sⱼ² for the corresponding partial image data by performing the calculations of Equation (1) and Equation (3). Then, the partial color average xₐᵥⱼ and the partial color variance Sⱼ² are stored in the characteristic amount storage section 37e of the memory 37.

When the partial color average xₐᵥⱼ and the partial color variance Sⱼ² have been obtained, the partial characteristic amount obtaining section 51 judges whether there is unprocessed partial image data left (S14-2). If it judges that there is unprocessed partial image data left, then the partial characteristic amount obtaining section 51 returns to Step S11-2 and carries out the same process (S11-2 to S13-2) for the next set of partial image data. On the other hand, if it is judged at Step S14-2 that there is no unprocessed partial image data left, then the processing with the partial characteristic amount obtaining section 51 ends. In this case, the overall characteristic amounts are obtained with the overall characteristic amount obtaining section 52 in Step S15-2.

### (2) Obtaining Overall Characteristic Amounts

The following is an explanation of how the overall characteristic amounts are obtained with the overall characteristic amount obtaining section 52 (S15-2). The overall characteristic amount obtaining section 52 obtains the overall characteristic amounts based on the plurality of partial characteristic amounts stored in the characteristic amount storage section 37e. As noted above, the overall characteristic amount obtaining section 52 obtains the color average and the color variance of the data of the targeted image as the overall characteristic amounts. The color average of the data of the targeted image is also referred to simply as “overall color average” The color variance of the data of the targeted image is also referred to simply as “overall color variance”. Moreover, if the partial color average of the above-mentioned j-th (j=1 to 64) set of partial image data is xₐᵥⱼ, then the overall color average xₐᵥ can be expressed by the Equation (4) below. In this Equation (4), m represents the number of partial images. The overall color variance S² can be expressed by the Equation (5) below. It can be seen that with this Equation (5), it is possible to obtain the overall color variance S² from the partial color averages xₐᵥⱼ, the partial color variances Sⱼ², and the overall color average xₐᵥ.

$$\begin{matrix}{x}_{av} = \frac{1}{m} {\sum }_{j} {x}_{avj} & ( 4 ) \\ \begin{matrix}{S}^{2} = \frac{1}{N - 1} ( {\sum }_{j = 1}^{m} {x}_{ji}^{2} - {Nx}_{av}^{2} ) \\ = \frac{1}{N - 1} ( ( n - 1 ) {\sum }_{j = 1}^{m} {S}_{j}^{2} + n {\sum }_{j = 1}^{m} {x}_{avj}^{2} - {Nx}_{av}^{2} )\end{matrix} & ( 5 )\end{matrix}$$

Consequently, the overall characteristic amount obtaining section 52 obtains the overall color average xₐᵥ and the overall color variance S² for the data of the targeted image by calculating the Equations (4) and (5). Then, the overall color average xₐᵥ and the overall color variance S² are stored in the characteristic amount storage section 37e of the memory 37.

The overall characteristic amount obtaining section 52 obtains the moment as another overall characteristic amount. In this embodiment, an image is to be classified, so that the positional distribution of colors can be quantitatively obtained through the moment. In this embodiment, the overall characteristic amount obtaining section 52 obtains the moment from the color average xₐᵥⱼ for each set of partial image data. Of 64 partial images shown in FIG. 19, a partial image defined by a vertical position J (J=1 to 8) and a horizontal position I (I=1 to 8) is indicated with coordinates (I, J). When a partial color average of data of the partial image defined with the coordinates (I, J) is indicated with X_{AV}(I, J), then the n-th moment mₘₕ in horizontal direction for the partial color average can be expressed as in Equation (6) below.

$${m}_{nh} = {\sum }_{I , J} {I}^{n} \times {x}_{av} ( I , J ) \qquad ( 6 )$$

Here, the value obtained by dividing the simple primary moment by the sum total of the partial color averages X_{AV}(I, J) is referred to as “primary centroid moment”. This primary centroid moment is as shown in Equation (7) below and indicates the centroid position in horizontal direction of the partial characteristic amount of partial color average. The n-th centroid moment, which is a generalization of this centroid moment is as expressed by Equation (8) below. Among the n-th centroid moments, the odd-numbered (n=1, 3 . . . ) centroid moments generally seem to indicate the centroid position. The even-numbered centroid moments generally seem to indicate the extent of the spread of the characteristic amounts near the centroid position.

$$\begin{matrix}{m}_{glh} = {\sum }_{I , J} I \times {x}_{av} ( I , J ) / {\sum }_{I , J} {x}_{av} ( I , J ) & ( 7 ) \\ {m}_{gnh} = {\sum }_{I , J} {( I - {m}_{glx} )}^{n} \times {x}_{av} ( I , J ) / {\sum }_{I , J} {x}_{av} ( I , J ) & ( 8 )\end{matrix}$$

The overall characteristic amount obtaining section 52 of this embodiment obtains six types of moments. More specifically, it obtains the primary moment in a horizontal direction, the primary moment in a vertical direction, the primary centroid moment in a horizontal direction, the primary centroid moment in a vertical direction, the secondary centroid moment in a horizontal direction, and the secondary centroid moment in a vertical direction. It should be noted that the combination of moments is not limited to this. For example, it is also possible to use eight types, adding the secondary moment in a horizontal direction and the secondary moment in a vertical direction.

By obtaining these moments, it is possible to recognize the color centroid and the extent of the spread of color near the centroid. For example, information such as “a red region spreads at the top portion of the image” or “a yellow region is concentrated near the center” can be obtained. With the classification process of the classification processing section 30I (see FIG. 16), the centroid position and the localization of colors can be taken into account, so that the accuracy of the classification can be improved.

### (2) Normalization of Characteristic Amounts

The overall classifier 30F and the partial image classifier 30G constituting a part of the classification processing section 30I perform the classification using support vector machines (also written “SVM”), which are explained later. These support vector machines have the property that their influence (extent of weighting) on the classification increases as the variance of the characteristic amounts becomes larger. Accordingly, the partial characteristic amount obtaining section 51 and the overall characteristic amount obtaining section 52 perform a normalization on the obtained partial characteristic amounts and the overall characteristic amounts. That is to say, the average and the variance is calculated for each characteristic amount, and normalized such that the average becomes “0” and the variance become “1”. More specifically, when μᵢ is the average value and σ₁ is the variance for the i-th characteristic amount xᵢ, then the normalized characteristic amount xᵢ′ can be expressed by the Equation (9) below.

xᵢ′=(xᵢ−μᵢ)/σᵢ (9)

Consequently, the partial characteristic amount obtaining section 51 and the overall characteristic amount obtaining section 52 normalize each characteristic amount by performing the calculation of Equation (9). The normalized characteristic amounts are stored in the characteristic amount storage section 37e of the memory 37, and used for the classification process with the classification processing section 30I. Thus, in the classification process with the classification processing section 30I, each characteristic amount can be treated with equal weight. As a result, the classification accuracy can be improved.

### (2) Summary of Characteristic Amount Obtaining Section 30E

The partial characteristic amount obtaining section 51 obtains partial color averages and partial color variances as the partial characteristic amounts, whereas the overall characteristic amount obtaining section 52 obtains overall color averages and overall color variances as the overall characteristic amounts. These characteristic amounts are used for the process of classifying the classification-target image with the classification processing section 30I. Therefore, the classification accuracy of the classification processing section 301 can be increased. This is because in the classification process, information about the coloring and information about the localization of colors is taken into account, which is obtained for the overall classification-target image as well as for the partial images.

### (2) Classification Processing Section 30I

The following is an explanation of the classification processing section 301. First, an overview of the classification processing section 30I is explained. As shown in FIGS. 16 and 17, the classification processing section 30I includes an overall classifier 30F, a partial image classifier 30G, and a consolidated classifier 30H. The overall classifier 30F classifies the scene of the classification-target image based on the overall characteristic amounts. The partial image classifier 30H classifies the scene of the classification-target image based on the partial characteristic amounts. The consolidated classifier 30H classifies the scene of classification-target image whose scene could be determined neither with the overall classifier 30F nor with the partial image classifier 30G. Thus, the classification processing section 30I includes a plurality of classifiers with different properties. This is in order to improve the classification properties. That is to say, scenes whose characteristics tend to appear in the overall classification-target image can be classified with high accuracy with the overall classifier 30F. By contrast, scenes whose characteristics tend to appear in a portion of the classification-target image can be classified with high accuracy with the partial image classifier 30G. As a result, it is possible to improve the classification properties of the classification-target image. Furthermore, for images where the scene could be determined neither with the overall classifier 30F nor with the partial image classifier 30G, the scene can be classified with the consolidated classifier 30H. Also with regard to this aspect, it is possible to improve the classification properties of the classification-target image.

### (2) Overall Classifier 30F

The overall classifier 30F includes sub-classifiers (also referred to simply as “overall sub-classifiers”), which correspond in number to the number of scenes that can be classified. The overall sub-classifiers classify whether a classification-target image belongs to a specific scene based on the overall characteristic amounts. As shown in FIG. 17, the overall classifier 30F includes, as overall sub-classifiers, a landscape scene classifier 61, an evening scene classifier 62, a night scene classifier 63, a flower scene classifier 64, and an autumnal scene classifier 65. Each overall sub-classifier classifies whether a classification-target image belongs to a specific scene. Furthermore, the various overall sub-classifiers classify also that a classification-target image does not belong to a specific scene.

These overall sub-classifiers each include a support vector machine and a decision section. That is to say, the landscape scene classifier 61 includes a landscape scene support vector machine 61a and a landscape scene decision section 61b, whereas the evening scene classifier 62 includes an evening scene support vector machine 62a and an evening scene decision section 62b. The night scene classifier 63 includes a night scene support vector machine 63a and a night scene decision section 63b, the flower scene classifier 64 includes a flower scene support vector machine 64a and a flower scene decision section 64b, and the autumnal scene classifier 65 includes an autumnal scene support vector machine 65a and an autumnal scene decision section 65b. As discussed below, each time a sample is entered, the support vector machines calculate a classification function value (probability information) depending on the extent to which the sample to be classified belongs to a specific category (scene). Moreover, the classification function value determined by the support vector machines is stored in the probability information storage section 37f of the memory 37.

Decision sections each decide, based on the classification function values obtained with the respective corresponding support vector machine, whether the classification-target image belongs to respective corresponding specific scenes. Then, if each decision section judges that the classification-target image belongs to the specific scene, a positive flag is set in a corresponding region of the positive flag storage section 37h. Besides, each decision section decides, based on the classification function values obtained with the support vector machine, whether the classification-target image does not belong to the specific scene. Then, if each decision section judges that the classification-target image does not belong to the specific scene, a negative flag is set in a corresponding region of the negative flag storage section 37i. It should be noted that the support vector machine is used in the partial image classifier 30G. Therefore, the support vector machine will be described with the partial image classifier 30G.

### (2) Partial Image Classifier 30G

The partial image classifier 30G includes several sub-classifiers (also referred to below simply as “partial sub-classifiers”), corresponding in number to the number of scenes that can be classified. The partial sub-classifiers classify, based on the partial characteristic amounts, whether or not a classification-target image belongs to a specific scene category. More specifically, each partial sub-classifier reads out partial characteristic amounts corresponding to a partial image from the characteristic amount storage section 37e of the memory 37. The partial sub-classifier performs calculation by the partial support vector machine (to be described later), using the partial characteristic amounts; based on the calculation results, the partial sub-classifier classifies whether or not each partial image belongs to a specific scene. Then, according to the number of partial images classified as belonging to the specific scene, each partial sub-classifier classifies whether or not the classification-target image belongs to the specific scene.

As shown in FIG. 17, the partial image classifier 30G includes an evening-scene partial sub-classifier 71, a flower-scene partial sub-classifier 72, and an autumnal-scene partial sub-classifier 73. The evening-scene partial sub-classifier 71 classifies whether the classification-target image belongs to the evening scene category. The flower-scene partial sub-classifier 72 classifies whether the classification-target image belongs to the flower scene category. The autumnal-scene partial sub-classifier 73 classifies whether the classification-target image belongs to the autumnal scene category. Comparing the number of scene types that can be classified by the overall classifier 30F with the number of scene types that can be classified by the partial image classifier 30G, the number of scene types that can be classified by the partial image classifier 30G is smaller. This is because the partial image classifier 30G has the purpose of supplementing the overall classifier 30F. That is, the partial image classifier 30G is provided for scenes that is difficult to be accurately classified by the overall classifier 30F.

Here, the images suitable for classification with the partial image classifier 30G are considered. First of all, a flower scene and an autumnal scene are considered. In both of these scenes, the characteristics of the scene tend to appear locally. For example, in an image of a flowerbed or a flower field, a plurality of flowers tend to accumulate in a specific portion of the image. In this case, the characteristics of a flower scene appear in the portion where the plurality of flowers accumulate, whereas characteristics that are close to a landscape scene appear in the other portions. This is the same for autumnal scenes. That is to say, if autumn leaves on a portion of a hillside are captured, then the autumn leaves accumulate on a specific portion of the image. Also in this case, the characteristics of an autumnal scene appear in one portion of the hillside, whereas the characteristics of a landscape scene appear in the other portions. Consequently, by using the flower-scene partial sub-classifier 72 and the autumnal-scene partial sub-classifier 73 as partial sub-classifiers, the classification properties can be improved even for flower scenes and for autumnal scenes, which are difficult to classify with the overall classifier 30F. That is to say, the classification is carried out for each partial image, so that even if it is an image in which the characteristics of the essential object, such as flowers or autumnal leaves, appear only in a portion of the image, it is possible to perform the classification with high accuracy. Next, evening scenes are considered. Also in evening scenes, the characteristics of the evening scene may appear locally. For example, let us consider an image in which the evening sun is captured as it sets at the horizon, and the image is captured immediately prior to the complete setting of the sun. In this image, the characteristics of a sunset scene appear at the portion where the evening sun sets, whereas the characteristics of a night scene appear in the other portions. Consequently, by using the evening-scene partial sub-classifier 71 as the partial sub-classifier, the classification properties can be improved even for evening scenes that are difficult to classify with the overall classifier 30F. It should be noted that, regarding these scenes whose characteristics tend to partly appear, there is a certain tendency, for each specific scene, in positions having a high probability that characteristics of the scene appear. A probability that characteristics of a scene appears in partial images is referred to as a presence probability hereinbelow.

Thus, the partial image classifier 30G mainly performs the classification of images that are difficult to classify accurately with the overall classifier 30F. Therefore, no partial sub-classifiers are provided for classification objects for which a sufficient accuracy can be attained with the overall classifier 30F. By employing this configuration, the configuration of the partial image classifier 30G can be simplified. Here, the partial image classifier 30G is configured by the main controller 31, so that a simplification of its configuration means that the size of the operating program executed by the CPU 36 and/or the volume of the necessary data is reduced. Through a simplification of the configuration, the necessary memory capacity can be reduced and the processing can be sped up.

### (2) Partial Image

The following is an explanation of an partial image that is classified by each partial sub-classifier of the partial image classifier 30G. In the present embodiment, the partial image is an image obtained by splitting width and height of the classification-target image into eight equal portions having a grid shape, as shown in FIG. 19. Accordingly, the classification-target image is partitioned into partial images of 64 blocks with eight by eight. Image data of the classification-target image is data of QVGA size (320×240 pixels=76800 pixels). Therefore, partial image data of one block consists of data of 1/64 of the size of that block (40×30 pixels=1200 pixels). As mentioned above, a partial image that is defined by a vertical position J (J=1 to 8) and a horizontal position I (I=1 to 8) in FIG. 19 is indicated with coordinates (I, J). In each partial sub-classifier of the present embodiment, based on information (to be described later) read out from the selection-information storage section 37k, partial images are classified in descending order by their presence probability.

### (2) Presence Probability

The presence probability is obtained by the following way: for example, using a plurality of sample images that belong to a specific scene (in the present embodiment, thousands of images), partitioning an entire region of each sample image into a plurality of partial regions, and counting for each partial region the number of sample images detected that characteristics of the specific scene appear in the partial region. More specifically, a presence probability for a partial region is a value obtained by dividing a total number of sample images by the number of sample images in which the characteristics of the specific scene appears in the partial region. Accordingly, in a certain partial region, if there is no sample image detected that the characteristics of the specific scene appears, the presence probability is “0”, a minimum; if it is detected that the characteristics of the specific scene appears in all sample images, the presence probability is “1”, a maximum. Since sample images are different in composition from each other, accuracy of the presence probability depends on the number of sample images. That is, if the number of sample images is small, it is difficult to accurately obtain a tendency of positions where the specific scene appears. For example, if the presence probability is obtained using one sample image, the presence probability is “1” in a partial region in which the specific scene appears, the presence probability is “0” in partial regions other than that partial image. In this case, if a classification-target image has a different composition from the sample image, in a partial region whose presence probability for a specific scene is “1”, characteristics of the specific scene does not appear, and in a partial region whose presence probability for the specific scene is “0”, the characteristics of the specific scene appears. In the present embodiment, when obtaining a presence probability of each partial region, a plurality of (e.g. thousands of) sample images having different compositions are used. Therefore, it is possible to accurately obtain a tendency of positions where a specific scene appears, so that the accuracy of a presence probability for each partial region can be improved.

Regarding cases where an entire region of each sample image is divided into 64 partial regions in a similar manner as a classification-target image is divided into partial images, examples of data that shows presence probabilities for each of partial regions are shown in FIG. 20 to FIG. 22. It should be noted that these 64 partial regions respectively correspond to the partial images shown in FIG. 19, for example. Accordingly, each partial region is indicated with coordinates (I, J) in the same manner as the partial images.

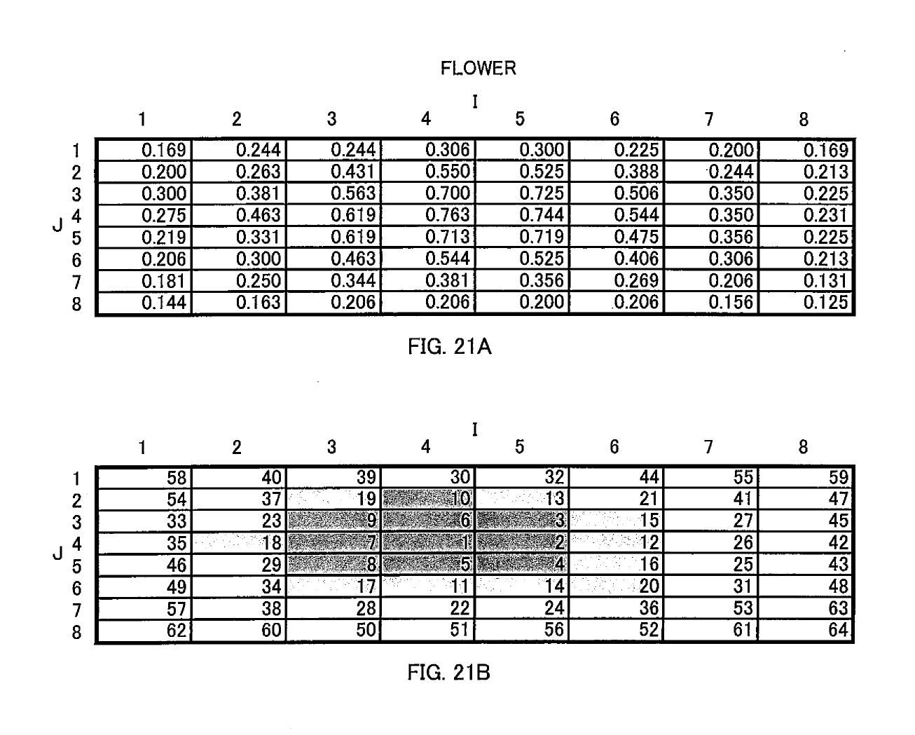

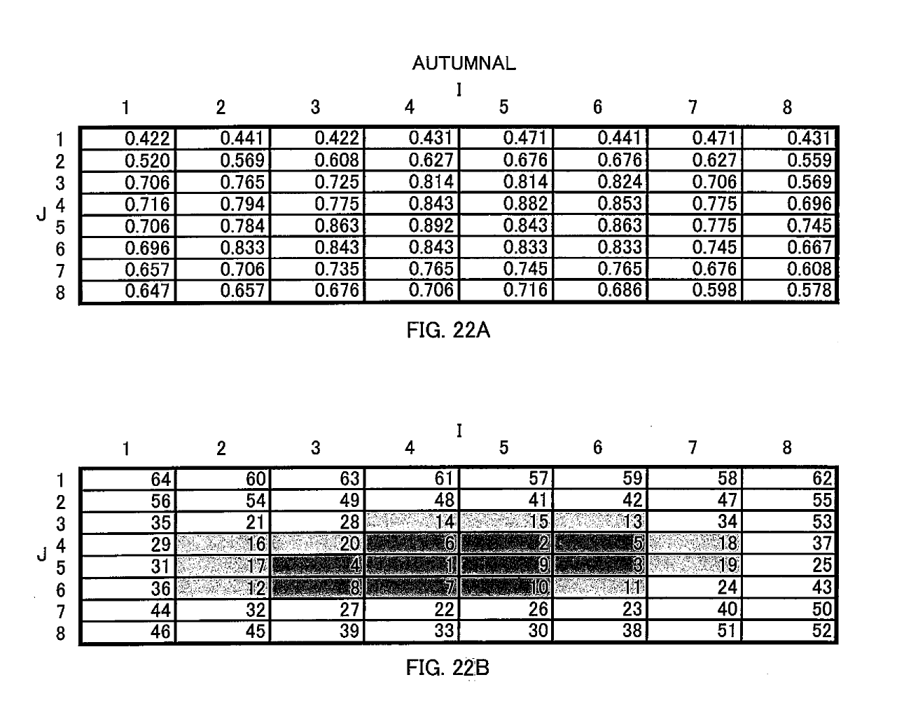

FIG. 20A is data showing presence probabilities for each partial region of the evening scene (hereinafter referred to as presence probability information); FIG. 20B is data showing an order of presence probabilities for each partial region of the evening scene (hereinafter referred to as presence-probability ranking information). Further, FIG. 21A shows the presence probability information of the flower scene, and FIG. 21B is the presence-probability ranking information of the flower scene. Further, FIG. 22A is the presence probability information of the autumnal scene, and FIG. 22B is the presence-probability ranking information of the autumnal scene. Values of these data are stored in the selection-information storage section 37k of the memory 37, as table data corresponding to values that indicate sets of coordinates respectively. It should be noted that, in FIGS. 20B, 21B, and 22B, in order to facilitate understanding of a distribution of partial regions having high presence probability, regions of top 10 presence probabilities (first to tenth) are filled with dark gray, and regions of next 10 presence probabilities (eleventh to twentieth) are filled with light gray.

For example, in the evening scene, evening sky usually appears in an upper half from the middle area of an image. That is, as shown in FIGS. 20A and 20B, the presence probability is high for partial regions in an upper half from the middle area of an entire regions, the presence probability is low for partial regions in other area (a lower half). In addition, for example, in the flower scene, in many of compositions, a flower is arranged in the middle of an entire region, as shown in FIG. 19. That is, as shown in FIGS. 21A and 21B, the presence probability is high for partial regions in the middle area of an entire region, and the presence probability is low for partial regions in the periphery of the entire region. Further, for example, in the autumnal scene, there are many cases in which autumn leaves on a portion of a hillside are captured, the presence probability is high in an area around the middle of an image to the lower portion, as shown in FIGS. 22A and 22B. As mentioned above, among the evening scene, the flower scene, and the autumnal scene, in which characteristics thereof tends to appear in a part of a main subject that is classified by the partial image classifier 30G, there is difference in distributions of position (coordinates) of partial images having high presence probability in a classification-target image.

### (2) Classification Order of Partial Images

Each partial sub-classifier classifies partial images in descending order by their presence probability based on at least either one of the presence probability information and the presence-probability ranking information that are read out selection-information storage section 37k. For example, if the evening-scene partial sub-classifier 71 performs the classification, partial images are selected in descending order by the presence probability of the evening scene, based on at least either one of the presence probability information shown in FIG. 20A and the presence-probability ranking information shown in FIG. 20B. That is, a partial image having coordinates (4,4), which has the highest presence probability of the evening scene, is selected first. Then, after the partial image is classified, a partial image having coordinates (5,4), which has the second highest presence probability, is selected second. Thereafter, partial images are selected in descending order by presence probability as mentioned above, and a partial image having coordinates (2,8), which has the lowest presence probability, is finally, 64th, selected.

Further, if the flower scene classifier 72 performs the classification, partial images are selected in descending order by presence probability of the flower scene, based on at least either one of the presence probability information shown in FIG. 21A and the presence-probability ranking information shown in FIG. 21B. Further, if autumnal scene classifier 73 performs the classification, partial images are selected in descending order by presence probability of the autumnal scene, based on at least either one of the presence probability information shown in FIG. 22A and the presence-probability ranking information shown in FIG. 22B.

Further, in the present embodiment, for each type of specific scenes to be classified, at least either one of the presence probability information and the presence-probability ranking information is stored, in advance, in the selection-information storage section 37k of the memory 37. Therefore, it is possible to perform classification in an order suitable for each type of specific scenes to be classified, so that the classification for each specific scene can be performed efficiently.

### (2) Configuration of Partial Sub-Classifier

The following is an explanation of the configuration of the partial sub-classifiers (the evening-scene partial sub-classifier 71, the flower-scene partial sub-classifier 72, and the autumnal-scene partial sub-classifier 73). As shown in FIG. 17, each partial sub-classifier includes a partial support vector machine, a detection number counter, and a decision section. That is, the evening-scene partial sub-classifier 71 includes an evening-scene partial support vector machine 71a, an evening-scene detection number counter 71b, and an evening-scene decision section 71c; the flower-scene partial sub-classifier 72 includes a flower-scene partial support vector machine 72a, a flower-scene detection number counter 72b, and a flower-scene decision section 72c. The autumnal-scene partial sub-classifier 73 includes an autumnal-scene support vector machine 73a, an autumnal-scene detection number counter 73b, and an autumnal-scene decision section 73c.

In each of these partial sub-classifiers, the partial support vector machine and the detection number counter correspond to a partial evaluation section that evaluates, based on the partial characteristic amounts, whether or not each partial image belongs to a specific scene. Further, each decision section judges, according to evaluation values obtained by a corresponding partial evaluation section, whether or not a classification-target image belongs to a specific scene.

The partial support vector machines of each partial sub-classifier (the evening-scene partial support vector machine 71a to autumnal-scene support vector machine 73a) are similar machine to the support vector machines included in each overall sub-classifier (the landscape scene support vector machine 61a to the autumnal scene support vector machine 65a). The support vector machine is explained in the following.

### (2) Support Vector Machines

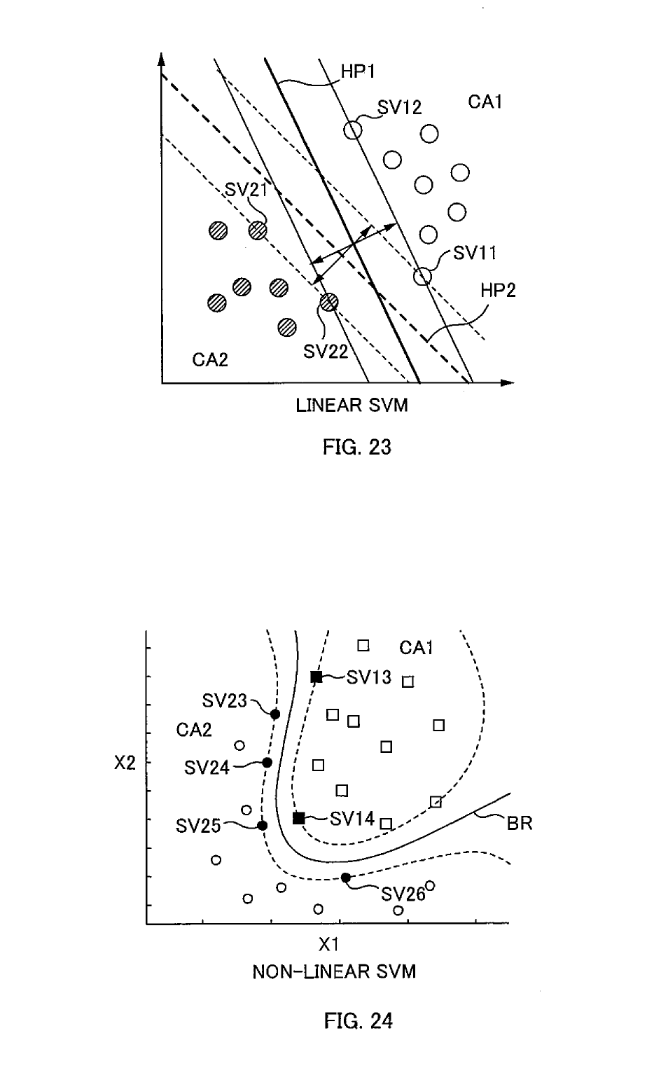

The support vector machines obtain probability information indicating whether the probability that the object to be classified belongs to a certain category is large or small, based on the characteristic amounts indicating the characteristics of the image to be classified. The basic form of the support vector machines is that of linear support vector machines. As shown in FIG. 23 for example, a linear support vector machine implements a linear classification function that is determined by sorting training with two classes, this classification function being determined such that the margin (that is to say, the region for which there are no support vectors in the training data) becomes maximal. In FIG. 23, of white circles, a circle that contributes to determination of a separation hyperplane (e.g. SV11) are support vectors belonging to a certain category CA1, and, of the hatched circles, a circle that contributes to determination of the separation hyperplane (e.g. SV22) are support vectors belonging to another category CA2. At the separating hyperplane that separates the support vectors belonging to category CA1 from the support vectors belonging to category CA2, the classification function (probability information) determining this separation hyperplane has the value “0”. FIG. 23 shows a separation hyperplane HP1 that is parallel to the straight line through the support vectors SV11 and SV12 belonging to category CA1 and a separation hyperplane HP2 that is parallel to the straight line through the support vectors SV21 and SV22 belonging to category CA2 as candidates for the separation hyperplane. In this example, the margin (a distance between a support vector to the separation hyperplane) of the separation hyperplane HP1 is larger than that of the separation hyperplane HP2, so that a classification function corresponding to the separation hyperplane HP1 is determined as the linear support vector machine.

Now, with linear support vector machines, their classification accuracy for images to be classified that cannot be linearly separated is low. It should be noted that the classification-target image that are handled by the multifunctional apparatus 1 correspond to objects to be classified that cannot be linearly separated. Accordingly, for such an object to be classified, the characteristic amounts are converted non-linearly (that is, mapped to a higher-dimensional space), and a non-linear support vector machine performing linear classification in this space is used. With such a non-linear support vector machine, a new number that is defined by a suitable number of non-linear functions is taken as data for the non-linear support vector machines. As shown diagrammatically in FIG. 24, in a non-linear support vector machine, the classification border BR becomes curved. In this example, of points represented by squares, a point that contributes to determination of classification border BR (e.g. SV13, SV14) are support vectors belonging to the category CA1, whereas, of points represented by circles, a point that contributes to determination of classification border BR (e.g. SV23 to SV26) are support vectors belonging to the category CA2. The training used for these support vectors is determined by the parameters of the classification function. It should be noted that the other points are used for the training, but not to the extent that they affect the optimization. Therefore, the volume of the training data (support vectors) used during the classification can be reduced by using support vector machines for the classification. As a result, it is possible to improve the accuracy of the obtained probability information even with limited training data.

### (2) Partial Support Vector Machines

Partial support vector machines included in the respective partial sub-classifiers (a evening-scene partial support vector machine 71a, flower-scene partial support vector machine 72a, and autumnal-scene support vector machine 73a) are non-linear support vector machines as mentioned above. In each of the support vector machines, the parameters in the classification function are determined by training based on different support vectors. As a result, the properties of each of the partial sub-classifiers can be optimized, and it is possible to improve the classification properties of the partial image classifier 30G. Each of the partial support vector machines outputs a numerical value, that is, a classification function value, which depends on the entered sample.

Each partial support vector machine is different from the support vector machines of the overall sub-classifier with regard to the fact that their training data is partial image data. Consequently, each partial support vector machine carries out a calculation based on the partial characteristic amounts indicating the characteristics of the portions to be classified. The more characteristics of the given scene to be classified the partial image has, the larger is the value of the calculation result by each partial support vector machine, that is, the classification function value. By contrast, the more characteristics of another scene that is not to be classified that partial image has, the smaller is that value of the calculation result. It should be noted that if that partial image has an even amount of both the characteristics of the given scene and the characteristics of the other scenes, then the classification function value obtained with the partial support vector machine becomes “0”.

Consequently, with regard to partial images where the classification function value obtained with a partial support vector machine has a positive value, more characteristics of the scene that is handled by that partial support vector machine appear than characteristics of other scenes, that is, the partial images are more likely to belong to the handled scenes. Thus, the classification function value obtained with the partial support vector machine corresponds to probability information indicating the probability that this partial image belongs to a certain scene. Therefore, that the classification function value is calculated by each of the partial support vector machines included in the partial evaluation section corresponds to that it is evaluated whether or not the partial image belongs to the specific scene. Further, that the partial image is sorted, depending on whether or not the classification function value is positive, as belonging or not belonging to the specific scene corresponds to the classification. In the present embodiment, each partial evaluation section classifies, based on the partial characteristic amounts, whether or not each partial image belongs to the specific scene. Each decision section judges, according to the number of partial images classified by each partial evaluation section as belonging to the specific scene, whether or not the classification-target image belongs to the specific scene.

The probability information obtained by each partial support vector machine is stored in the probability information storage section 37f of the memory 37. The partial sub-classifiers of the present embodiment are respectively provided for their corresponding specific scenes, and the partial sub-classifies each perform, with their respective partial support vector machine, the classification of whether or not an image belongs to a specific scene. Therefore, the properties of the partial sub-classifiers can be optimized individually.

The partial support vector machines of the present embodiment perform their calculation taking into account the overall characteristic amounts in addition to the partial characteristic amounts. Each partial sub-classifier performs the classification based on the calculation result. This is for increasing the classification accuracy of the partial images. The following is an explanation of this aspect. The partial images contain less information than the overall image. Therefore, it occurs that the classification of scenes is difficult. For example, if a given partial image has characteristics that are common for a given scene and another scene, then their classification becomes difficult. Let us assume that the partial image is an image with a strong red tone. In this case, it may be difficult to classify with the partial characteristic amounts alone whether the partial image belongs to an evening scene or whether it belongs to an autumnal scene. In this case, it may be possible to classify the scene to which this partial image belongs by taking into account the overall characteristic amounts. For example, if the overall characteristic amounts indicate an image that is predominantly black, then the probability is high that the partial image with the strong red tone belongs to an evening scene. And if the overall characteristic amounts indicate an image that is predominantly green or blue, then the probability is high that the partial image with the strong red tone belongs to an autumnal scene. Thus, the calculation is performed while taking into account the overall characteristic amounts and each partial sub-classifier performs the classification based on the calculation result, so that the classification accuracy of the partial support vector machines can be increased.

### (2) Detection Number Counters

The detection number counters (evening-scene detection number counter 71b to autumnal-scene detection number counter 73b) functions under the counter section 37g of the memory 37. The detection number counters each count the number of partial images classified as belonging to a specific scene.

Each detection number counter is set to “0” as an initial value, and is incremented (+1) every time when obtaining a classification result that a classification function value obtained with a corresponding support vector machine is greater than zero, that is, a classification result that the characteristics of a corresponding scene are stronger than the characteristics of the other scenes. In short, the detection number counter counts the number of partial images classified as belonging to the specific scene to be classified. Count values (evaluation value) of the detection number counters are reset when, for example, a process for another classification-target image is performed. In the following explanation, count values of each detection number counter are referred to as the number of detected images.

### (2) Decision Sections

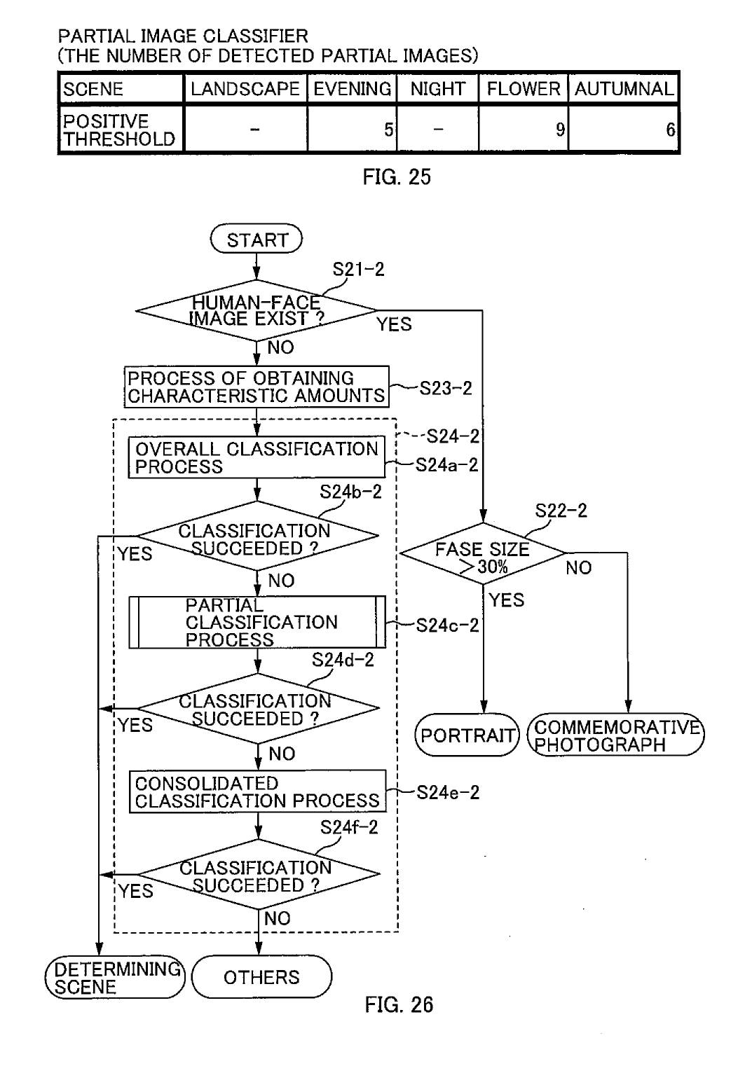

Each of decision sections (the evening-scene decision section 71c, the flower-scene decision section 72c, and the autumnal-scene decision section 73c) is configured with the CPU 36 of the main controller 31, for example, and decides, according to the number of images detected by a corresponding detection number counter, whether or not a classification-target image belongs to a specific scene. Thus, even if the characteristics of the specific scene appears only in a portion of the classification-target image, the classification can be performed with high accuracy by deciding whether or not the classification-target image belongs to the specific scene, according to the number of detected images. Accordingly, classification accuracy can be increased. More specifically, if the number of detected images exceed a predetermined threshold stored in the control parameter storage section 37b of the memory 37, each decision section decides that a classification-target image in question belongs to a specific scene. The predetermined threshold gives a positive decision that the classification-target image belongs to the scene handled by the partial sub-classifier. Consequently, in the following explanations, this threshold for making such a positive decision is also referred to as “positive threshold”. According to the value of the positive threshold, the number of partial images necessary to decide that a classification-target image belongs to a specific scene, that is, a ratio of a region of the specific scene in the classification-target image is decided, so that classification accuracy can be adjusted by setting the positive threshold. It can be considered that the best number of detected images for this decision is different from each specific scene in terms of processing speed and classification accuracy. Therefore, the positive threshold is set to different value depending on each of specific scenes to be classified by the respective partial sub-classifiers. In this embodiment, as shown in FIG. 25, values are set to “5” for the evening scene, “9” for the flower scene, and “6” for the autumnal scene. That is, for example, in the evening-scene partial sub-classifier 71, when the number of images detected by the evening-scene detection number counter 71b exceeds “5”, the evening-scene decision section 71c decides that a classification-target image in question belongs to the evening scene. Thus, since a positive threshold is set for each specific scene, it is possible to perform the classification suitable to the specific scene.

In the present embodiment, first, the evening-scene partial sub-classifier 71 performs the classification. The evening-scene partial support vector machine 71a of the evening-scene partial sub-classifier 71 obtains a classification function value based on partial characteristic amounts of each partial image. The evening-scene detection number counter 71b counts classification results whose classification function values obtained by the evening-scene partial support vector machine 71a are positive and obtains the number of detected images. The evening-scene decision section 71c decides, according to the number of detected images detected by the evening-scene detection number counter 71b, whether or not a classification-target image in question belongs to the evening scene. As a result of this classification, if it cannot be decided that the classification-target image belongs to the evening scene, the evening-scene decision section 71c lets the flower-scene decision section 72c of the subsequent flower-scene partial sub-classifier 72 use the flower-scene partial support vector machine 72a and flower-scene detection number counter 71b, and lets the flower-scene decision section 72c decide whether or not each partial image belongs to the flower scene. Further, As a result of this classification, if it cannot be decided that the classification-target image belongs to the flower scene, the flower-scene decision section 72c lets the autumnal-scene decision section 73c of the subsequent autumnal-scene partial sub-classifier 73 use the autumnal-scene partial support vector machine 73a and autumnal-scene detection number counter 71b, and lets the autumnal-scene decision section 73c decide whether or not each partial image belongs to the autumnal scene. In other words, if each decision section of the partial image classifier 30G cannot decide, based on a classification by a certain partial evaluation section, that a classification-target image belongs to a certain specific scene, the decision section uses another partial evaluation section and lets it classify whether or not each partial image belongs to the other specific scene. Since the classification is performed by each partial sub-classifier individually in this manner, the reliability of the classification can be increased.

Further, the partial sub-classifiers of the present embodiment each classify partial images in descending order of presence probability, as mentioned above. Thus, partial images are classified in descending order by presence probability for each specific scene, so that the necessary number of classification processes of the partial images to reach a positive threshold can decrease, and the time required for the classification processes can be shortened. Accordingly, classification processing speed can be increased.

### (2) Consolidated Classifier 30H

As mentioned above, the consolidated classifier 30H classifies the scenes of classification-target image for which the scene could be decided neither with the overall classifier 30F nor with the partial image classifier 30G. The consolidated classifier 30H of the present embodiment classifies scenes based on the probability information determined with the overall sub-classifiers (the support vector machines). More specifically, the consolidated classifier 30H selectively reads out the probability information for positive values from the plurality of sets of probability information stored in the probability information storage section 37f of the memory 37 in the overall classification process by the overall classifier 30F. Then, the probability information with the highest value among the sets of probability information that have been read out is specified, and the corresponding scene is taken as the scene of the classification-target image. By providing such a consolidated classifier 30H, it is possible to classify suitable scenes, even when the characteristics of the scene to which the image belongs do not appear strongly in the classification-target image. That is to say, it is possible to improve the classification properties.

### (2) Result Storage Section 37j

The result storage section 37j stores the classification results of the object to be classified that have been determined by the classification processing section 30I. For example, if, based on the classification results according to the overall classifier 30F and the partial image classifier 30G, a positive flag is stored in the positive flag storage section 37h, then the information is stored that the classification-target image belongs to the scene corresponding to this positive flag. If a positive flag is set that indicates that the classification-target image belongs to a landscape scene, then result information indicating that the classification-target image belongs to a landscape scene is stored. Similarly, if a positive flag is set that indicates that the classification-target image belongs to an evening scene, then result information indicating that the classification-target image belongs to an evening scene is stored. It should be noted that for classification-target image for which a negative flag has been stored for all scenes, result information indicating that the targeted image belongs to another scene is stored. The classification result stored in the result storage section 37j is looked up by later processes. In the multifunctional apparatus 1, the image enhancement section 30C (see FIG. 15) looks up the classification result and uses it for an image enhancement. For example, the contrast, brightness, color balance or the like can be adjusted in accordance with the classified scene.

### (2) Image Classification Process

The following is an explanation of the image classification process. In execution of this image classification process, the printer-side controller 30 functions as a face detection section 30A and a scene classification section 30B (characteristic amount obtaining section 30E, overall classifier 30F, partial image classifier 30G, consolidated classifier 30H, and result storage section 37j). In this case, the CPU 36 of the main controller 31 run a computer program stored in the memory 37. Accordingly, an image classification process is described as a process of the main controller 31. Moreover, the computer program executed by the main controller 31 includes code for realizing the image classification process.

As shown in FIG. 26, the main controller 31 reads in data of an image to be processed, and judges whether it contains a face image (S21-2). The presence of a face image can be judged by various methods. For example, the main controller 31 can determine the presence of a face image based on the presence of a region whose standard color is skin-colored and the presence of an eye image and a mouth image within that region. In the present embodiment, it is assumed that a face image of at least a certain area (for example, at least 20×20 pixels) is subject to detection. If it is judged that there is a face image, then the main controller 31 obtains the proportion of the area of the face image in the classification-target image and judges whether this proportion exceeds a predetermined threshold (e.g. 30%) (S22-2). Then, if the predetermined threshold exceeds 30%, the main controller 31 classifies the classification-target image as a portrait scene (Yes in S22-2). If the predetermined threshold is not exceeded does not exceed 30%, then the main controller 31 classifies the classification-target image as a scene of a commemorative photograph (No in S22-2). The classification results are stored in the result storage section 37j.

If the classification-target image contains no face image (No in S21-2), then the main controller 31 carries out a process of obtaining characteristic amounts (S23-2). In the process of obtaining the characteristic amounts, the characteristic amounts are obtained based on the data of the classification-target image. That is to say, the overall characteristic amounts indicating the overall characteristics of the classification-target image and the partial characteristic amounts indicating the partial characteristics of the classification-target image are obtained. It should be noted that the obtaining of these characteristic amounts has already been explained above (see S11-2 to S15-2, FIG. 18), and further explanations are omitted. Then, the main controller 31 stores the obtained characteristic amounts in the characteristic amount storage section 37e of the memory 37.

When the characteristic amounts have been obtained, the main controller 31 performs a scene classification process (S24-2). In this scene classification process, the main controller 31 first functions as the overall classifier 30F and performs an overall classification process (S24a-2). In this overall classification process, classification is performed based on the overall characteristic amounts. Then, when the classification-target image could be classified by the overall classification process, the main controller 31 determines the scene of the classification-target image as the classified scene (YES in S24b-2). For example, it determines the image to be the scene for which a positive flag has been stored in the overall classification process. Then, it stores the classification result in the result storage section 37j. If the scene was not determined in the overall classification process, then the main controller 31 functions as a partial image classifier 30G and performs a partial image classification process (S24c-2). In this partial image classification process, classification is performed based on the partial characteristic amounts. Then, if the classification-target image could be classified by the partial image classification process (YES in S24d-2), the main controller 31 determines the scene of the classification-target image as the classified scene, and stores the classification result in the result storage section 37j. It should be noted that the details of the partial image classification process are explained later. If the scene was also not determined by the partial image classifier 30G (NO in S24d-2), then the main controller 31 functions as a consolidated classifier 30H and performs a consolidated classification process (S24e-2). In this consolidated classification process, the main controller 31 reads out, among pieces of probability information calculated in the overall classification process, the probability information with positive values from the probability information storage section 37f and determines the image to be a scene corresponding to the probability information with the largest value, as explained above. Then, if the classification-target image could be classified by the consolidated classification process, the main controller 31 determines the scene of the classification-target image as the classified scene (YES in S24f-2). On the other hand, if the classification-target image could also not be classified by the consolidated classification process (if there is no positive probability information calculated by the overall classification process), and negative flags have been stored for all scenes, then the classification-target image is classified as being another scene (NO in S24f-2). It should be noted that in the consolidated process, the main controller 31 functioning as the consolidated classifier 30H first judges whether negative flags are stored for all scenes. Then, if it is judged that negative flags are stored for all scenes, the image is classified as being another scene, based on this judgment. In this case, the processing can be performed by confirming only the negative flags, so that the processing can be sped up.

### (2) Partial Image Classification Process

The following is an explanation of the partial image classification process. As mentioned above, the partial classification process is performed when a classification-target image cannot be classified in the overall classification process. Accordingly, at the stage when the partial classification process is performed, the positive flag is not stored in the positive flag storage section 37h. Further, for a scene which it is decided in the overall classification process that the classification-target image does not belong to, the negative flag is stored in a corresponding region of the negative flag storage section 37i. Further, based on a presence probability obtained using a plurality of sample images, the selection-information storage section 37k stores in advance at least either one of the presence probability information (see FIGS. 20A, 21A, and 22A) and the presence-probability ranking information (see FIGS. 20B, 21B, and 22B) (also referred to as information indicating the presence probability).

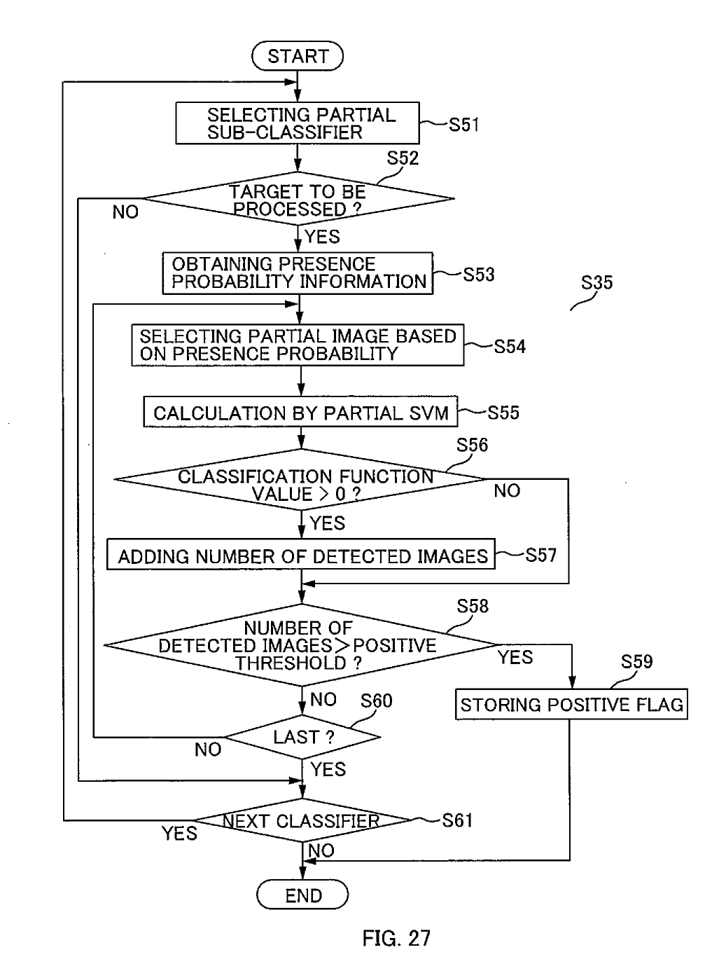

As shown in FIG. 27, the main controller 31 first selects a partial sub-classifier to perform classification (S51). As shown in FIG. 17, in the partial image classifier 30G of the present embodiment, the evening-scene partial sub-classifier 71, the flower-scene partial sub-classifier 72, and the autumnal-scene partial sub-classifier 73 are ordered by priority in that order. Consequently, the evening-scene partial sub-classifier 71, which has the highest priority, is selected in the initial selection process. Then, when the classification with the evening-scene partial sub-classifier 71 is finished, the flower-scene partial sub-classifier 72, which has the second highest priority, is selected, and after the flower-scene partial sub-classifier 72, the autumnal-scene partial sub-classifier 73, which has the lowest priority, is selected.

When a partial sub-classifier has been selected, the main controller 31 judges whether the scene classified by the selected partial sub-classifier is subjected to classification processing (S52). This judgment is carried out based on negative flags that are stored in the negative flag storage section 37i in the overall classification process by the overall classifier 30F. This is because when positive flags are set with the overall classifier 30F, the scene is decided by the overall classification process and the partial classification process is not carried out, and because, when positive flag is stored in the partial classification process, the scene is decided and the classification process ends as mentioned below. For a scene that is not to be classified, that is, a scene for which the negative flag is set in the overall classification process, the classification process is skipped (NO in S52). Therefore, unnecessary classification processing is eliminated, so that the processing can be sped up.

On the other hand, if in Step S52 it is decided that the scene classified by the selected partial sub-classifier is subjected to classification processing (YES in S52), the main controller 31 reads out, from the selection-information storage section 37k, information indicating a presence probability of the corresponding specific scene (either one of the presence probability information and the presence-probability ranking information) (S53). Then, based on the obtained information indicating the presence probability, the main controller 31 selects a partial image (S54). If the information obtained from the selection-information storage section 37k is the presence probability information, the main controller 31 sorts partial images in descending order by presence probability; a value indicating each set of the coordinates corresponds to a value of each presence probability, for example. As a result of this sorting, the main controller 31 selects a partial image corresponding to coordinates having the highest presence probability and shifts to a next partial image in descending order by presence probability. On the other hand, if the presence-probability ranking information is stored in the selection-information storage section 37k, the main controller 31 selects a partial image having coordinates corresponding to a value indicating the highest presence probability and shifts to a next partial image in descending order by presence probability. That is, in Step S54, a partial image having the highest presence probability is selected among partial images for which the classification process has not been performed yet.

Then, the main controller 31 reads out partial characteristic amounts corresponding to partial image data of the selected partial image from the characteristic amount storage section 37e of the memory 37. Based on the partial characteristic amounts, a calculation with the partial support vector machine is carried out (S55). In other words, probability information for the partial image is obtained based on the partial characteristic amounts. It should be noted that, in the present embodiment, in addition to the partial characteristic amounts, the overall characteristic amounts are also read out from the characteristic amount storage section 37e, and the calculation is performed by taking into account the overall characteristic amounts. The main controller 31 functions as a partial evaluation section corresponding to a scene to be processed, and obtains the classification function value serving as the probability information by a calculation based on the partial color average, the partial color variance, and the like. The main controller 31 classifies, based on the obtained classification function value, whether or not the partial image belongs to a specific scene (S56). More specifically, if the obtained classification function value corresponding to a certain partial image is a positive value, the partial image is classified as belonging to the specific scene (YES in S56). A count value of a corresponding detection number counter (the number of detected images) is incremented (+1) (S57). If the classification function value is not a positive value, then the partial image is classified as not belonging to the specific scene, and the count value of the detection number counter stays the same (NO in S56). By obtaining the classification function value in this manner, the classification whether or not the partial image belongs to the specific scene can be performed depending on whether or not the classification function value is positive.

If, for the partial image, probability information has been obtained and counters has been processed, the main controller 31 functions as each decision section, and decides whether the number of detected images is greater than a positive threshold (S58). For example, if a positive threshold shown in FIG. 25 is set in the control parameter storage section 37b of the memory 37 and the evening-scene partial sub-classifier 71 performs the classification, when the number of detected images exceeds “5”, the evening-scene decision section 71c judges that the classification-target image is the evening scene, and then a positive flag corresponding to the evening scene is stored in the positive flag storage section 37h (S59). Further, if the classification is performed in the flower-scene partial sub-classifier 72, when the number of detected images exceeds “9”, the flower-scene decision section 72c decides that the classification-target image is the flower scene, and then a positive flag corresponding to the flower scene is stored in the positive flag storage section 37h. If the positive flag are stored, the classification ends without performing remaining classification processes.

If the sum of the number of detected images and the number of remaining images is not greater than positive threshold (NO in S58), it is decided whether the partial image for which the classification has been performed is the last image (S60). For example, as shown in FIG. 19, if the number of partial images to be classified is 64, it is decided whether the partial image is 64th image. This decision can be made based on the number of partial images for which the classification has performed.

Here, if it is decided that the partial image is not the last image (NO in S60), the procedure advances to Step S54. Then, based on at least either one of the presence probability information and the presence-probability ranking information, the above-described process is repeated for a partial image having the next highest presence probability, that is, for a partial image having the highest presence probability among partial images for which the classification process has not been performed yet. On the other hand, if it is decided, in Step S60, that the partial image is the last image (YES in S60), or, if in Step S52 it is not decided that the scene classified by the selected partial sub-classifier is subjected to classification processing, (NO in S52), it is decided whether or not there is a next partial sub-classifier to be handled (S61). At this stage, the main controller 31 judges whether the process has been finished that is handled by the autumnal-scene partial sub-classifier 73, which has the lowest priority. If the process handled by the autumnal-scene partial sub-classifier 73 has been finished, the main controller 31 judges that there is no next partial sub-classifier (NO in S61), and stops a series of procedures of the partial classification process. On the other hand, if the process handled by the autumnal-scene partial sub-classifier 73 has not been finished (YES in S61), the main controller 31 selects a partial sub-classifier having the next highest priority (S51), and the above-described process is repeated.

It should be noted that in the above-mentioned embodiment, when a classification function value obtained by the partial evaluation section is positive, the detection number counter of each partial sub-classifier is incremented and counts the number of partial images classified as belonging to a specific scene. However, it is possible to increment the classification function value itself with the detection number counter. Depending on a comparison between a count value (evaluation value) of the detection number counter and a positive threshold set for the classification function value, it may be judged, with a corresponding decision section, whether or not a classification-target image belongs to a specific scene.

### (2) Comprehensive Description

Each partial evaluation section of each partial sub-classifier of the present embodiment classifies whether or not a partial image belongs to a specific scene, in descending order by presence probability, based on at least either one of the presence probability information and the presence-probability ranking information that are read out from the selection-information storage section 37 of the memory 37. Partial images are classified in descending order by presence probability in this manner, so that it is possible to increase classification process speed for classifying partial images.

Further, if the number of detected images, which is obtained by the counter section, exceeds the positive threshold, each decision section of each partial sub-classifier decides that the classification-target image belongs to the specific scene. Therefore, it is possible to adjust classification accuracy by changing setting of the positive threshold.

Further, for each type of specific scenes to be classified (in the present embodiment, for each of the evening scene, flower scene, and autumnal scene), at least either one of the presence probability information and the presence-probability ranking information is stored in the selection-information storage section 37k of the memory 37. Therefore, the classification for each specific scene can be performed efficiently.

The partial image classifier 30G has partial evaluation sections for each type of the specific scene to be classified. Therefore, the properties of each of partial evaluation sections can be optimized, and it is possible to improve the classification properties of the partial sub-classifier. Further, positive thresholds are set for each of a plurality of specific scenes. This allows each of partial sub-classifiers to perform the classification suitable to the respective specific scenes.

Further, if in the classification by the partial evaluation sections of the partial sub-classifier, it cannot be decided that a classification-target image belongs to a corresponding specific scene, each decision section of the partial image classifier 30G uses a partial evaluation section of a subsequent partial sub-classifier, and decide which scene the classification-target image belongs to. Therefore, classification can be carried out by each of the partial sub-classifiers individually, so that the reliability of the classification can be increased.

Further, in calculation by the partial support vector machine of each partial sub-classifier, overall characteristic amounts are taken into account in addition to partial characteristic amounts. Thus, since calculation is performed taking into account the overall characteristic amounts in addition to the partial characteristic amounts, it is possible to increase classification accuracy.

### Other Embodiment

In the embodiment explained above, the object to be classified is an image based on image data, and the classification apparatus is the multifunctional apparatus 1. However, the classification apparatus classifying images is not limited to the multifunctional apparatus 1. For example, it may also be a digital still camera DC, a scanner, or a computer that can execute a computer program for image processing (for example, retouching software). Moreover, it can also be an image display device that can display images based on image data or an image data storage device that stores image data.

Furthermore, in the embodiment above, a multifunctional apparatus 1 was described, which classifies the scene of a classification-target image, but this includes therein also the disclosure of a scene classification apparatus, a scene classification method, a method for using a classified scene (for example a method for enhancing an image, a method for printing, and a method for ejecting a liquid based on a scene), a computer program, and a storage medium storing a computer program or code.

Moreover, regarding the classifiers, the above-described embodiment explained support vector machines, but as long as they can classify the scene of a classification-target image, there is no limitation to support vector machines. For example, it is also possible to use a neural network or the AdaBoost algorithm as a classifier.

What is claimed is:

1. A scene classification apparatus, comprising:
a characteristic amount obtaining section that obtains a partial characteristic amount indicating a characteristic of a partial image that is a portion of a classification-target image;
a partial classification section that classifies, based on the partial characteristic amount obtained by the characteristic amount obtaining section, whether or not the partial image belongs to a predetermined scene;
a detection section that detects the number of the partial images classified by the partial classification section as belonging to the predetermined scene; and
a decision section that decides, according to the number of the partial images detected by the detection section, whether or not the classification-target image belongs to the predetermined scene.

2. A scene classification apparatus according to claim 1, wherein:
if the number of the partial images detected by the detection section exceeds a predetermined threshold,
the decision section decides that the classification-target image belongs to the predetermined scene.

3. A scene classification apparatus according to claim 2, wherein:
the detection section detects the number of remaining images that has not been classified by the partial classification section, among all of the partial images obtained from the classification-target image, and
if a sum of the number of the remaining images detected by the detection section and the number of the partial images belonging to the predetermined scene does not reach the predetermined threshold,
the decision section decides that the classification-target image does not belong to the predetermined scene.

4. A scene classification apparatus according to claim 2, wherein:
the partial classification section is provided for each type of the predetermined scene to be classified.

5. A scene classification apparatus according to claim 4, wherein:
the predetermined threshold is set for each of a plurality of the predetermined scenes.

6. A scene classification apparatus according to claim 4, wherein:
if in a classification with a first partial classification section, it cannot be decided that the classification-target image belongs to a first predetermined scene,
in a classification with a partial classification section other than the first partial classification section, the decision section decides whether or not the classification-target image belongs to a predetermined scene other than the first predetermined scene.

7. A scene classification apparatus according to claim 1, wherein:
the partial classification section obtains probability information that indicates a probability that the partial image belongs to the predetermined scene, from the partial characteristic amount corresponding to the partial image, and
classifies, based on the probability information, whether or not the partial image belongs to the predetermined scene.

8. A scene classification apparatus according to claim 7, wherein:
the partial classification section is a support vector machine that obtains the probability information from the partial characteristic amount.

9. A scene classification apparatus according to claim 1, wherein:
the characteristic amount obtaining section obtains an overall characteristic amount that indicates a characteristic of the classification-target image,
based on the partial characteristic amount and the overall characteristic amount that are obtained by the characteristic amount obtaining section, the partial classification section classifies whether or not the partial image is the predetermined scene.

10. A scene classification method, comprising:
obtaining a partial characteristic amount that indicates a characteristic of a partial image that is a portion of a classification-target image;
classifying, based on the obtained partial characteristic amount, whether or not the partial image belongs to a predetermined scene;
detecting the number of the partial images classified as belonging to the predetermined scene; and
judging, according to the number of the detected partial images, whether or not the classification-target image belongs to the predetermined scene.

11. A scene classification apparatus, comprising:
a storage section that stores at least either one of presence probability information indicating, for each of partial regions, a presence probability that a characteristics of the predetermined scene appear, and presence-probability ranking information indicating an order of the presence probability for a plurality of the partial regions, the partial regions being obtained by dividing an entire region of an image belonging to a predetermined scene;
a characteristic amount obtaining section that obtains a partial characteristic amount indicating a characteristic of a partial image that is a portion of a classification-target image and that corresponds to the partial region;
a partial evaluation section that evaluates, based on the partial characteristic amount obtained by the characteristic amount obtaining section, whether or not the partial image belongs to the predetermined scene, in a descending order by the presence probability based on at least either one of the presence probability information and the presence-probability ranking information that are read out from the storage section; and
a decision section that decides, according to an evaluation value obtained by the partial evaluation section, whether or not the classification-target image belongs to the predetermined scene.

12. A scene classification apparatus according to claim 11, wherein:
the partial evaluation section classifies, based on the partial characteristic amount, whether or not the partial image belongs to the predetermined scene, and
if the number of the partial images classified by the partial evaluation section as belonging to the predetermined scene exceeds a predetermined threshold, the decision section decides that the classification-target image belongs to the predetermined scene.

13. A scene classification apparatus according to claim 12, wherein:
at least either one of the presence probability information and the presence-probability ranking information is stored in the storage section for each type of the predetermined scene to be classified.

14. A scene classification apparatus according to claim 13, wherein:
the partial evaluation section is provided for each type of the predetermined scene, and
each of the partial evaluation sections classifies the partial image in a descending order by the presence probability of the predetermined scene, based on at least either one of the presence probability information and the presence-probability ranking information that are read out from the storage section corresponding to the predetermined scene to be classified.

15. A scene classification apparatus according to claim 14, wherein:
the predetermined threshold is set for each of a plurality of the predetermined scenes, and
if the number of the partial images classified by the partial evaluation section as belonging to a corresponding one of the predetermined scenes exceeds the predetermined threshold set to the corresponding predetermined scene, the decision section decides that the classification-target image belongs to that predetermined scene.

16. A scene classification apparatus according to claim 14, wherein:
if it cannot be decided, based on a classification with a first partial evaluation section, that the classification-target image belongs to a first predetermined scene,
the decision section classifies, with a partial evaluation section other than the first partial evaluation section, whether or not the partial image belongs to a predetermined scene other than the first predetermined scene.

17. A scene classification apparatus according to claim 11, wherein:
the characteristic amount obtaining section obtains an overall characteristic amount that indicates a characteristic of the classification-target image, and
the partial evaluation section evaluates, based on the partial characteristic amount and the overall characteristic amount that are obtained by the characteristic amount obtaining section, whether or not the partial image belongs to the predetermined scene, in a descending order by the presence probability based on at least either one of the presence probability information and the presence-probability ranking information that are read out from the storage section.
